(19) United States
(12) Patent Application Publication
(10) Pub. No.: US 2024/0056280 A1
(43) Pub. Date: Feb. 15, 2024

(54) INDICATING SUBBAND CONFIGURATIONS IN SUBBAND FULL DUPLEX OPERATION

(71) Applicant: QUALCOMM Incorporated, San Diego, CA (US)

(72) Inventors: Qian ZHANG, Basking Ridge, NJ (US); Yan ZHOU, San Diego, CA (US); Muhammad Sayed Khairy ABDELGHAFFAR, San Jose, CA (US); Tao LUO, San Diego, CA (US); Abdelrahman Mohamed Ahmed Mohamed IBRAHIM, San Diego, CA (US)

(21) Appl. No.: 18/309,459

(22) Filed: Apr. 28, 2023

Related U.S. Application Data
(60) Provisional application No. 63/397,655, filed on Aug. 12, 2022.

(51) Int. Cl. H04L 5/14; H04W 72/23; H04W 72/04

(52) U.S. Cl. CPC H04L 5/14; H04W 72/23; H04W 72/04

(57) ABSTRACT

Certain aspects of the present disclosure provide techniques for indicating subband configurations in subband full duplex (SBFD) operation. An example method that may be performed by a user equipment (UE) includes receiving signaling indicating at least one of time or frequency locations of at least one uplink (UL) subband and at least one downlink (DL) subband for subband full duplex (SBFD) communications; and performing SBFD communications, in one or more symbols or slots, based on the signaling.

### CROSS REFERENCE TO RELATED APPLICATIONS

This application claims benefits of and priority to U.S. Provisional Patent Application No. 63/397,655, filed on Aug. 12, 2022, which is assigned to the assignee hereof and herein incorporated by reference in the entirety as if fully set forth below and for all applicable purposes.

### BACKGROUND

### Field of the Disclosure

Aspects of the present disclosure relate to wireless communications, and more particularly, to techniques for indicating subband configurations in subband full duplex (SBFD) operation.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes receiving signaling indicating at least one of time or frequency locations of at least one uplink (UL) subband and at least one downlink (DL) subband for subband full duplex (SBFD) communications; and performing SBFD communications, in one or more symbols or slots, based on the signaling.

Another aspect provides a method for wireless communications by a network entity. The method includes transmitting signaling indicating at least one of time or frequency locations of at least one UL subband and at least one DL subband for SBFD communications; and performing SBFD communications, in one or more symbols or slots, based on the signaling.

Yet another aspect provides an apparatus for wireless communications at a user equipment (UE). The apparatus includes: a processor; memory coupled with the processor; and instructions stored in the memory and executable by the processor to cause the UE to: receive signaling indicating at least one of time or frequency locations of at least one uplink (UL) subband and at least one downlink (DL) subband for subband full duplex (SBFD) communications; and perform SBFD communications, in one or more symbols or slots, based on the signaling.

Yet another aspect provides an apparatus for wireless communications at a network entity. The apparatus includes: a processor; memory coupled with the processor; and instructions stored in the memory and executable by the processor to cause the network entity to: transmit signaling indicating at least one of time or frequency locations of at least one UL subband and at least one DL subband for SBFD communications; and perform SBFD communications, in one or more symbols or slots, based on the signaling.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example subband configuration of a component carrier during a slot, in accordance with aspects of the present disclosure.

FIG. 6 depicts in block form a network entity operating in full duplex mode, according to aspects of the present disclosure.

FIG. 7 depicts in block form a gNodeB and two user equipments (UEs) performing subband full duplex (SBFD) operations, according to aspects of the present disclosure.

FIG. 8 depicts an example call flow for communications in a network between a network entity and a UE.

FIG. 9 depicts an example call flow for communications in a network between a network entity and a UE.

FIGS. 10A, 10B, 10C, and 10D depict example subband frequency configuration patterns that do not include flexible subbands, in accordance with aspects of the present disclosure.

FIGS. 11A, 11B, and 11C depict example subband frequency configuration patterns that include flexible subbands, in accordance with aspects of the present disclosure.

FIGS. 12A and 12B depict example timelines 1200 and 1250 of subband configurations, according to aspects of the present disclosure.

FIG. 13 depicts an example call flow for communications in a network between a network entity and a UE.

FIGS. 14A and 14B depict example semi-static uplink (UL) bandwidth part (BWP) switching patterns, according to aspects of the present disclosure

FIG. 15 depicts example downlink (DL) BWPs, in accordance with aspects of the present disclosure.

FIG. 16 depicts frequency resources of example BWPs, in accordance with aspects of the present disclosure.

FIG. 17 depicts frequency resources of example subbands in an example DL BWP, in accordance with aspects of the present disclosure.

FIG. 18 depicts frequency resources of example subbands in an example UL BWP, in accordance with aspects of the present disclosure.

FIG. 19 depicts a method for wireless communications.

FIG. 20 depicts a method for wireless communications.

FIG. 21 depicts aspects of an example communications device.

FIG. 22 depicts aspects of an example communications device.

### DETAILED DESCRIPTION

Aspects of the present disclosure provide apparatuses, methods, processing systems, and computer-readable mediums for indicating subband configurations in subband full duplex (SBFD) operation.

In typical cellular communications systems operating using time domain duplexing (TDD), the network (e.g., a network entity, such as a base station (BS) or a node of a disaggregated BS) may indicate to user equipments (UEs) a configuration of transmit directions (e.g., uplink (UL) or downlink (DL)) for slots or subframes of a frame, referred to as a TDD UL/DL configuration. Such a TDD UL/DL configuration may be broadcast in a system information block (SIB) in a cell. Changing a TDD UL/DL configuration in a cell is typically done by broadcasting a SIB with the new TDD UL/DL configuration in the cell. Broadcasting a SIB having a changed TDD UL/DL configuration typically involves paging all UEs in the cell to notify the UEs of the change, and thus takes some time to accomplish. In aspects of the present disclosure, a cell may operate using subband full duplex (SBFD) communications, in which a network entity uses some antennas to transmit one or more DL signals via one or more subbands of a component carrier (CC) to one or more UEs while simultaneously using other antennas to receive UL signals via other subbands of the CC from other UEs. SBFD communications allows for flexibility in scheduling communications, but the flexibility is very limited if the SBFD configuration is communicated to UEs via SIB s, as is done with TDD UL/DL configurations.

In aspects of the present disclosure, techniques are provided to transmit SBFD configurations to UEs in a cell without using SIB broadcasts. The SBFD configurations may be communicated to UEs via a medium access control (MAC) control element (MAC-CE) or a downlink control information (DCI).

Transmitting SBFD configurations via MAC-CEs or DCIs may enable and/or improve flexibility in SBFD configurations. Improving the flexibility of SBFD communications may increase an UL duty cycle in the cell for at least some UEs and lead to a latency reduction in the cell, because UEs may be able to receive DL signals in UL-only slots. The improved SBFD communications may also lead to an UL coverage improvement. In addition, SBFD may enhance system capacity, resource utilization, and/or spectrum efficiency. SBFD may also enable flexible and dynamic UL/DL resource adaption according to UL and DL traffic in the cell in a robust manner.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

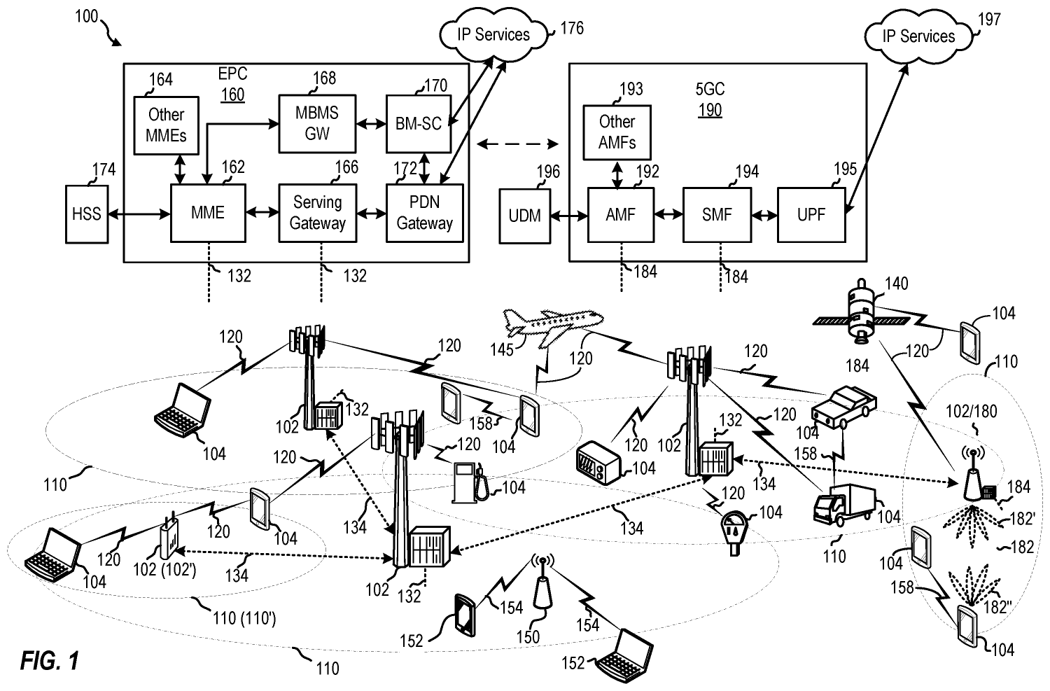

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

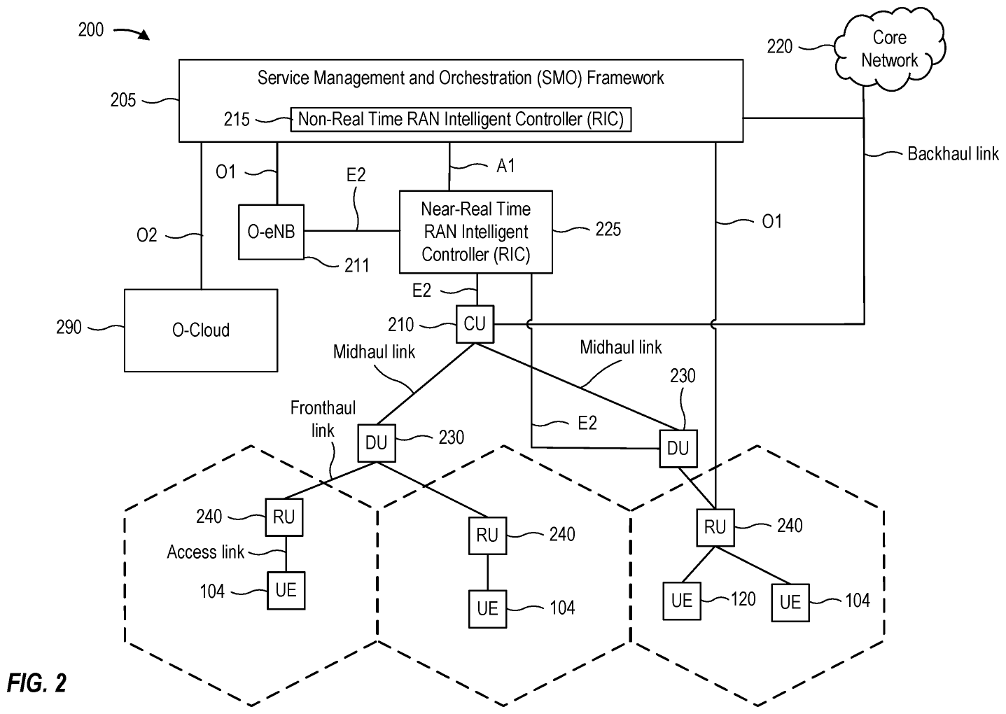

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3r d Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240, and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

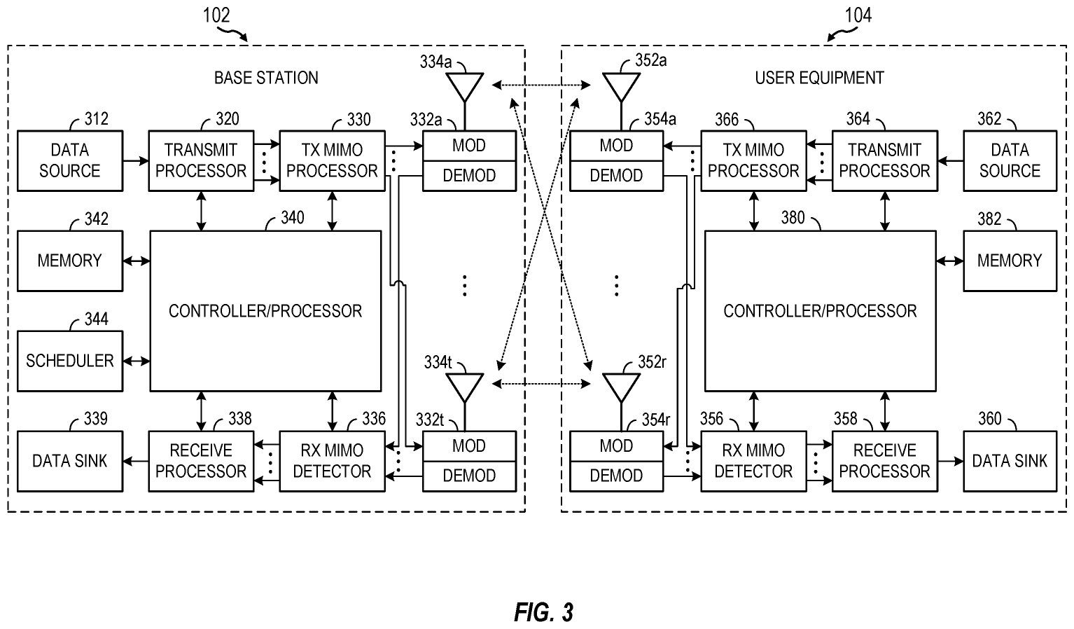

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

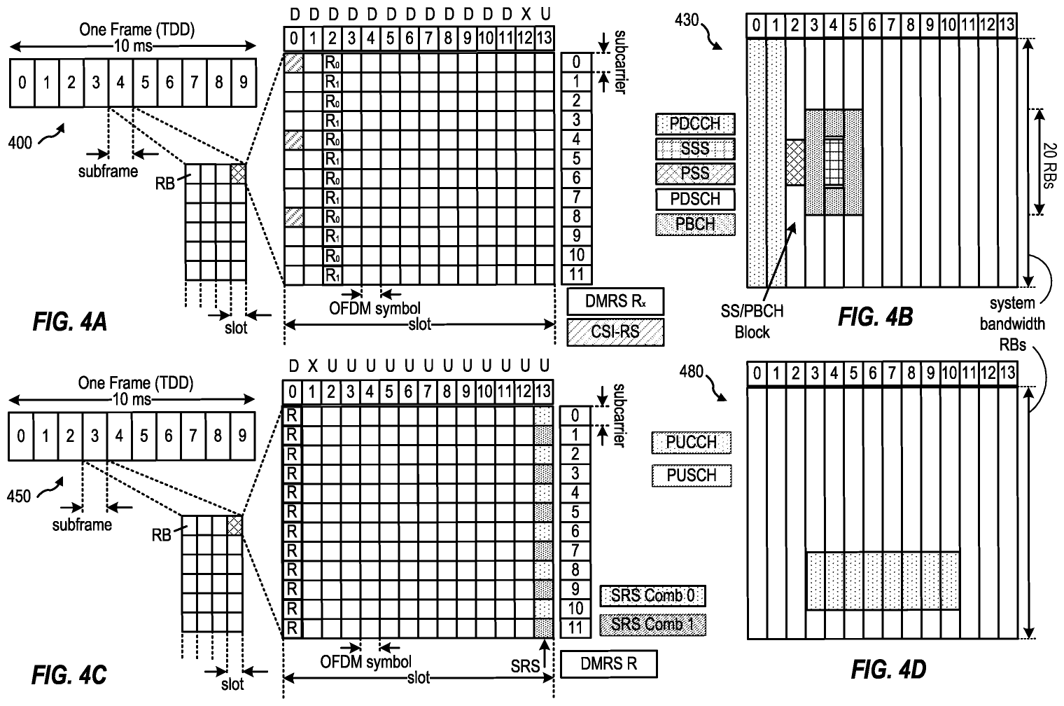

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RB s (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIB s), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Indicating Subband Configurations in Subband Full Duplex Operation

In typical cellular communications systems operating using time domain duplexing (TDD), the network (e.g., a network entity, such as a BS or a node of a disaggregated BS) may indicate to the UEs a TDD UL/DL configuration of transmit directions for slots or subframes of a frame. Such a TDD UL/DL configuration may be broadcast in a SystemInformationBlockType1 (SIB1) in a cell and may have a form similar to DDDDDDDFUU, where each “D” indicates a slot that is for DL transmissions, each “U” indicates a slot that is for UL transmissions, and each “F” indicates a flexible slot that may be dynamically switched between being used for UL transmissions and DL transmissions.

Changing a TDD UL/DL configuration in a cell is typically done by broadcasting a SIB1 with the new TDD UL/DL configuration in the cell. Broadcasting a SIB1 having a changed TDD UL/DL configuration typically involves paging all UEs in the cell to notify the UEs of the change, and thus takes some time to accomplish.

In aspects of the present disclosure, a cell may operate using subband full duplex (SBFD) communications, in which a network entity uses some antennas to transmit one or more DL signals via one or more subbands of a component carrier (CC) to one or more UEs while simultaneously using other antennas to receive UL signals via other subbands of the CC from other UEs. SBFD communications may increase an UL duty cycle in the cell for at least some UEs, which may lead to a latency reduction because UEs may be able to receive DL signals in UL-only slots and lead to an UL coverage improvement. In addition, SBFD may enhance system capacity, resource utilization, and/or spectrum efficiency. SBFD may also enable flexible and dynamic UL/DL resource adaption according to UL and DL traffic in the cell in a robust manner.

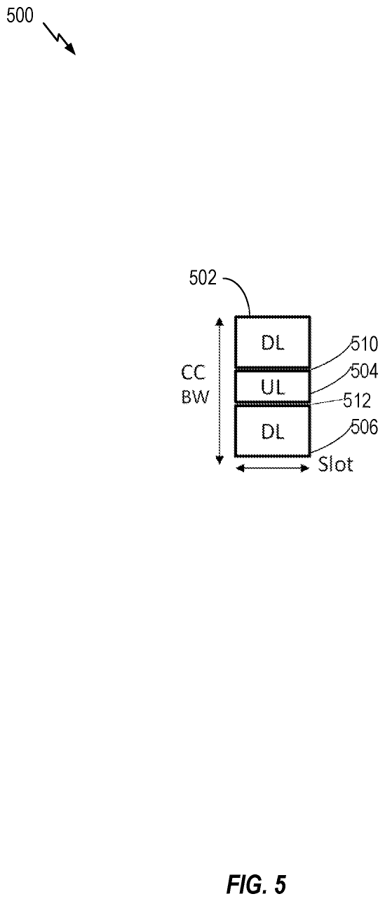

FIG. 5 depicts an example subband configuration 500 of a component carrier during a slot, in accordance with aspects of the present disclosure. In the example subband configuration, an UL subband 504 is configured between two DL subbands 502 and 506. Guard bands (GBs) 510 and 512 separate the UL subband from each of the two DL subbands.

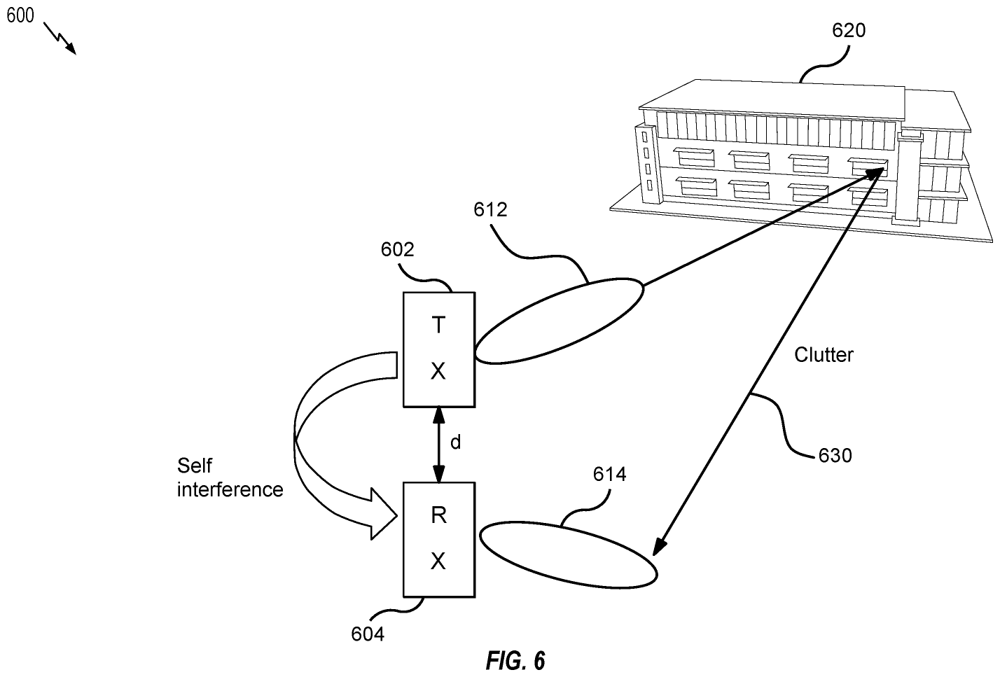

FIG. 6 depicts in block form a scenario 600 of a network entity (e.g., BS 102) operating in full duplex mode, according to aspects of the present disclosure. As illustrated, a first antenna 602 of the network entity transmits a signal using a first beam 612 while a second antenna 604 of the network entity receives another signal using a second beam 614. The first antenna may be separated from the second antenna by a distance d. The signal from the first antenna may be directly received by the second antenna, resulting in self interference with the other signal being received by the second antenna. In addition, the first signal may reflect from an object 620 in the environment, and the reflected signal may also be received by the second antenna, resulting in clutter 630 affecting reception of the other signal by the second antenna. Both the self interference and the clutter may be at least partially mitigated by causing the transmitted signal from the first antenna to be on a different subband from the signal being received by the second antenna.

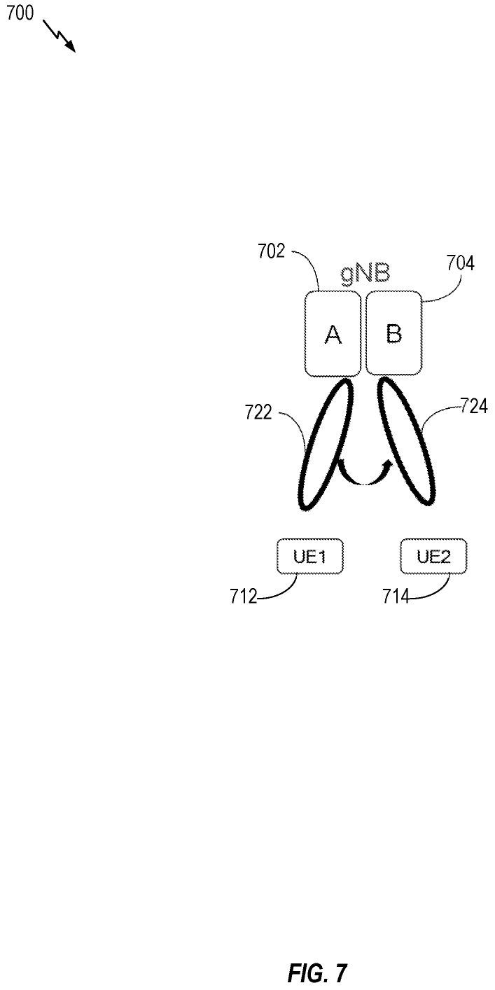

FIG. 7 depicts in block form a gNB 700 and two UEs 712 and 714 performing SBFD operations, according to aspects of the present disclosure. As illustrated, a first antenna 702 of the gNB transmits a signal on a first subband using a first beam 722 while a second antenna 704 of the network entity receives another signal on a second subband using a second beam 724. As illustrated, the first signal may interfere with reception of the second signal by the second antenna.

According to aspects of the present disclosure, in order to support SBFD operation in a cell, a network entity (e.g., BS 102) may transmit signaling indicating at least one of time or frequency locations of at least one uplink (UL) subband and at least one downlink (DL) subband for subband full duplex (SBFD) communications in the cell. The network entity may then perform SBFD communications in one or more transmission time intervals (TTIs, e.g., slots or subframes), based on the signaling.

In aspects of the present disclosure, in order to support SBFD operation in a cell, a UE (e.g., UE 104) may receive signaling indicating at least one of time or frequency locations of at least one uplink (UL) subband and at least one downlink (DL) subband for SBFD communications in the cell. The UE may then perform SBFD communications in one or more transmission time intervals (TTIs, e.g., slots or subframes), based on the signaling.

### Example Operations of Entities in a Communications Network

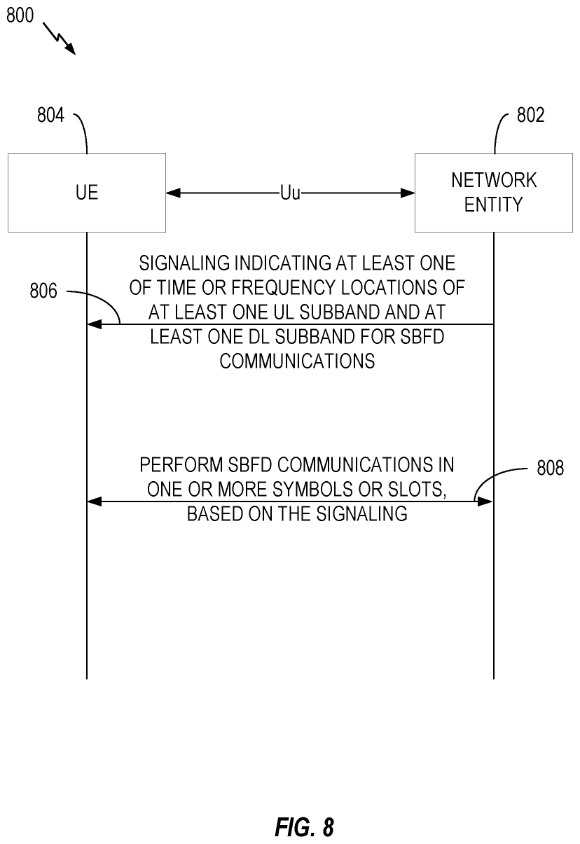

FIG. 8 depicts an example call flow 800 for communications in a network between a network entity 802 and a user equipment (UE) 804. In some aspects, the network entity 802 may be an example of the BS 102 depicted and described with respect to FIGS. 1 and 3 or a disaggregated base station depicted and described with respect to FIG. 2. Similarly, the UE 804 may be an example of UE 104 depicted and described with respect to FIGS. 1 and 3. However, in other aspects, UE 104 may be another type of wireless communications device and BS 102 may be another type of network entity or network node, such as those described herein.

At 806, the network entity transmits signaling indicating at least one of time or frequency locations of at least one UL subband and at least one DL subband for SBFD communications. At 808, the UE and the network entity perform SBFD communications in one or more symbols or slots, based on the signaling. For example, the UE may transmit an UL signal to the network entity in an UL subband indicated in the signaling. In another example, the network entity may transmit a DL signal to the UE in a DL subband indicated in the signaling.

According to aspects of the present disclosure, a network entity may transmit a medium access control (MAC) control element (MAC-CE) or a downlink control information (DCI) conveying configurations of DL subbands, UL subbands, and guard bands to inform UEs in a cell in order to support SBFD communications in the cell. Transmitting such a MAC-CE or DCI may be an example of transmitting signaling indicating at least one of time or frequency locations of at least one UL subband and at least one DL subband for SBFD communications as shown at 806 in FIG. 8.

In aspects of the present disclosure, the MAC-CE or DCI may also include an offset value indicating a time (given in symbols or slots) to start using the included configurations of DL subbands, UL subbands, and guard bands when performing SBFD communications. For example, a MAC-CE or DCI may indicate that a UE should start using the included configurations K symbols or slots after receiving the MAC-CE or DCI or K symbols after receiving transmitting an acknowledgment (ACK) of the MAC-CE or the DCI.

In aspects of the present disclosure, a cell may continue using the configurations for DL subbands, UL subbands, and guard bands in the MAC-CE or DCI for SBFD communications until a network entity transmits another MAC-CE or DCI with new configurations for DL subbands, UL subbands, and guard bands or an indication that the cell is returning to half duplex operation.

According to aspects of the present disclosure, a UE may continue using configurations for DL subbands, UL subbands, and guard bands received in MAC-CE or DCI for SBFD communications with a cell until the UE receives another MAC-CE or DCI with new configurations for DL subbands, UL subbands, and guard bands or an indication that the cell is returning to half duplex operation.

In aspects of the present disclosure, a network entity indicate a symbol and slot configuration pattern indicating slots and symbols within the slots for which a subband configuration is effective. For example, a set of symbols starting at symbol i and ending at symbol j in each slot in a window of M slots may be configured as SBFD symbols. Note that each slot of the M slots may have a different or same start symbol and end symbol for the SBFD symbols. For some slots, the starting symbol and ending symbol may both be 0, which would mean that there are no SBFD symbols in that slot. For some slots, all of the symbols in the slot could be SBFD symbols.

Extension: the time configuration pattern may contain single or multiple frequency configuration patterns. If containing multiple frequency configuration patterns, then the time pattern may contain total of M slots—with M1 slots of frequency configuration pattern 1, M2 slots of frequency configuration pattern 2,

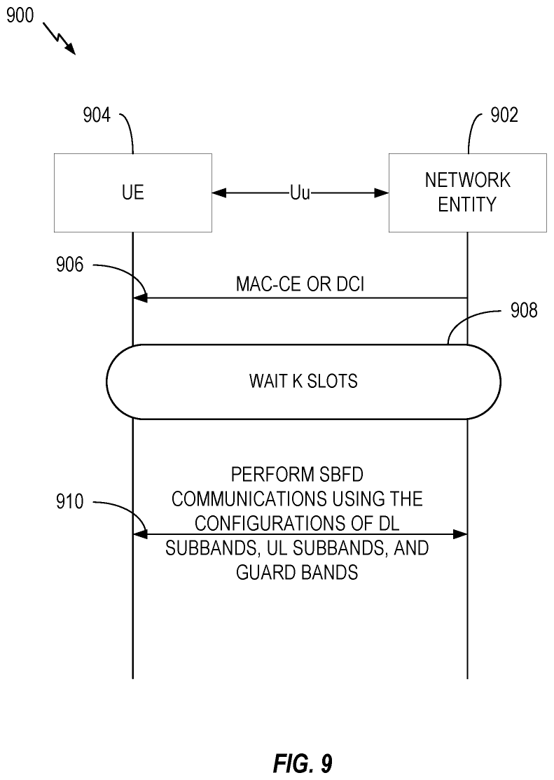

FIG. 9 depicts an example call flow 900 for communications in a network between a network entity 902 and a user equipment (UE) 904. In some aspects, the network entity 902 may be an example of the BS 102 depicted and described with respect to FIGS. 1 and 3 or a disaggregated base station depicted and described with respect to FIG. 2. Similarly, the UE 904 may be an example of UE 104 depicted and described with respect to FIGS. 1 and 3. However, in other aspects, UE 104 may be another type of wireless communications device and BS 102 may be another type of network entity or network node, such as those described herein.

At 906, the network entity transmits a MAC-CE or DCI conveying configurations of DL subbands, UL subbands, and guard bands and an offset value of K slots after receiving the MAC-CE or DCI. At 908, the UE and the network entity both wait K slots before starting using the configurations of DL subbands, UL subbands, and guard bands for SBFD communications. At 910, the UE and the network entity begin performing SBFD communications using the configurations of DL subbands, UL subbands, and guard bands. For example, the UE may transmit an UL signal to the network entity in an UL subband indicated in the MAC-CE or DCI. In another example, the network entity may transmit a DL signal to the UE in a DL subband indicated in the MAC-CE or DCI.

According to aspects of the present disclosure, a MAC-CE or DCI may convey configurations of DL subbands and UL subbands by indicating or listing resource blocks (RBs) for each DL subband and each UL subband. The MAC-CE or DCI may include, for each DL or UL subband, a starting RB index i and at least one of an ending RB index j or a bandwidth (in number of RBs) of the subband. A UE receiving the MAC-CE or DCI can determine the guard band RBs implicitly as being the RBs between the configured DL and UL subbands.

Additionally or alternatively, a MAC-CE or DCI may convey configurations of DL subbands and UL subbands by indicating or listing resource block (RB) sets for each of DL subband and each UL subband. The MAC-CE or DCI may include, for each DL or UL subband, one or more RB set indices for the RB sets included in that subband. A UE receiving the MAC-CE or DCI can determine the guard band RB sets implicitly as being the RB sets between the configured DL and UL subbands.

According to aspects of the present disclosure, a network entity may indicate RBs or RB sets to include in a DL subband, an UL subband, or a guard band by including a resource indication vector (RIV) in the MAC-CE or DCI configuring the subbands. A UE receiving a MAC-CE or DCI configuring subbands for SBFD operations may determine which RBs or RB sets to include in a DL subband(s), an UL subband(s), or a guard band(s), based on one or more RIVs in the MAC-CE or DCI configuring the subbands.

In aspects of the present disclosure, a MAC-CE or DCI may convey configurations of DL subbands and UL subbands by indicating an explicit subband frequency configuration pattern. The explicit subband frequency configuration pattern may indicate, in frequency order, whether each of the subbands is a downlink subband, an uplink subband, or a flexible subband. For example, an explicit subband frequency configuration pattern may be D/U/D when the configuration is for an uplink subband between two downlink subbands. The MAC-CE or DCI may also indicate the RBs or RB sets for each subband in the pattern, as described herein.

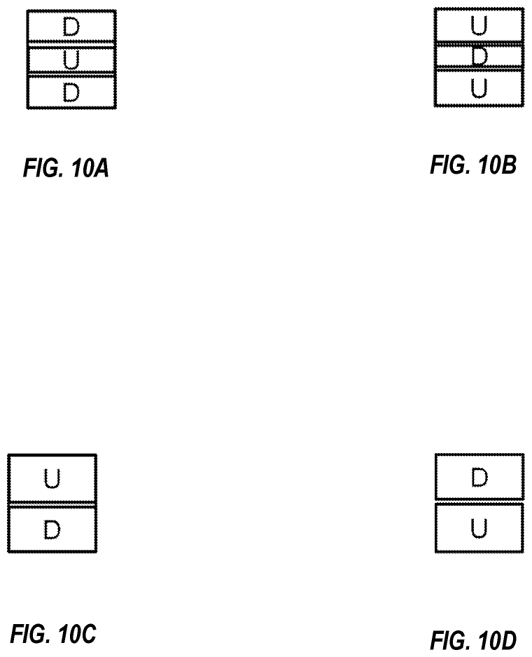

FIGS. 10A, 10B, 10C, and 10D depict example subband frequency configuration patterns that do not include flexible subbands, in accordance with aspects of the present disclosure. In the example subband frequency configuration patterns, “D” refers to downlink subbands, and “U” refers to uplink subbands. FIG. 10A depicts an example D/U/D subband frequency pattern. FIG. 10B depicts an example U/D/U subband frequency pattern. FIG. 10C depicts an example U/D subband frequency pattern. FIG. 10D depicts an example D/U subband frequency pattern. While each of the depicted example frequency patterns shows subbands of approximately equal size, the present disclosure is not so limited, and subbands of different sizes can be allocated within a component carrier.

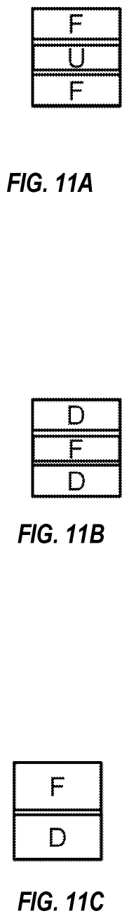

FIGS. 11A, 11B, and 11C depict example subband frequency configuration patterns that include flexible subbands, in accordance with aspects of the present disclosure. In the example subband frequency configuration patterns, “D” refers to downlink subbands, “U” refers to uplink subbands, and “F” refers to flexible subbands. FIG. 11A depicts an example F/U/F subband frequency pattern. FIG. 11B depicts an example D/F/D subband frequency pattern. FIG. 11C depicts an example F/D subband frequency pattern. While each of the depicted example frequency patterns show s subbands of approximately equal size, the present disclosure is not so limited, and subbands of different sizes can be allocated within a component carrier.

According to aspects of the present disclosure, a MAC-CE or DCI may convey a configuration of DL subbands and UL subbands by indicating or listing resource blocks (RBs) for each guard band between the DL subbands and UL subbands in the configuration. The MAC-CE or DCI may include, for each guard band, a starting RB index i, at least one of an ending RB index j or a bandwidth (in number of RBs) of the guard band, and an explicit indication of a direction (e.g., UL or DL) of one of the subbands. A UE receiving the MAC-CE or DCI can determine the RBs in the subbands implicitly as being the RBs between the configured guard bands. The UE receiving the MAC-CE or DCI can also determine the direction (e.g., UL or DL) of each subband by determining the direction of each subband as being the opposite direction of a next subband, starting from the subband with the explicitly indicated direction in the MAC-CE or DCI. For example, for the subband frequency configuration pattern depicted in FIG. 10A, a network entity may transmit a MAC-CE or DCI indicating the RBs included in the guard bands between the UL subband and the two DL subbands and indicating that the first subband is a DL subband. A UE receiving the MAC-CE or DCI may then determine the RBs included in each of the subbands as being the subbands not included in the guard bands, with the first subband being a DL subband, the second subband being an UL subband, and the third subband being a DL subband.

In aspects of the present disclosure, a DL and/or UL BWP configured by a network entity may not change when the network entity transmits a MAC-CE or DCI with a DL and/or UL subband indication.

According to aspects of the present disclosure, a network entity will ensure the RBs or RB sets for each DL or UL subband are contained within a current DL or UL active BWP. In this case, a network entity may only transmit a MAC-CE or DCI with a DL and UL subband indication for DL and UL subbands that are each contained with a current DL or UL active BWP.

In aspects of the present disclosure, a network entity may configure the RBs or RB sets for each DL or UL subband to extend to beyond (e.g., into a higher or lower frequency) the current DL or UL active BWP. In this case, a network entity may transmit a MAC-CE or DCI with a DL and UL subband indication for DL and UL subbands without considering the current DL or UL active BWPs.

In aspects of the present disclosure, a DL and/or UL BWP configured by a network entity may be changed by the network entity when the network entity transmits a MAC-CE or DCI with a DL and UL subband indication.

According to aspects of the present disclosure, a UE may adapt (e.g., change the frequency bands of) the current active DL and UL BWPs to follow the corresponding indicated DL and UL subbands without a network entity transmitting any additional signaling for BWP switching.

In another alternative, a network entity may be required to transmit an additional BWP switching signal to change the DL and UL BWPs according to the indicated DL and UL subband configuration transmitted by the network entity. The DL and UL subband configuration may not be considered effective for a UE before the UE receives a BWP switch command to switch to a BWP configuration matching the DL and UL subband configuration.

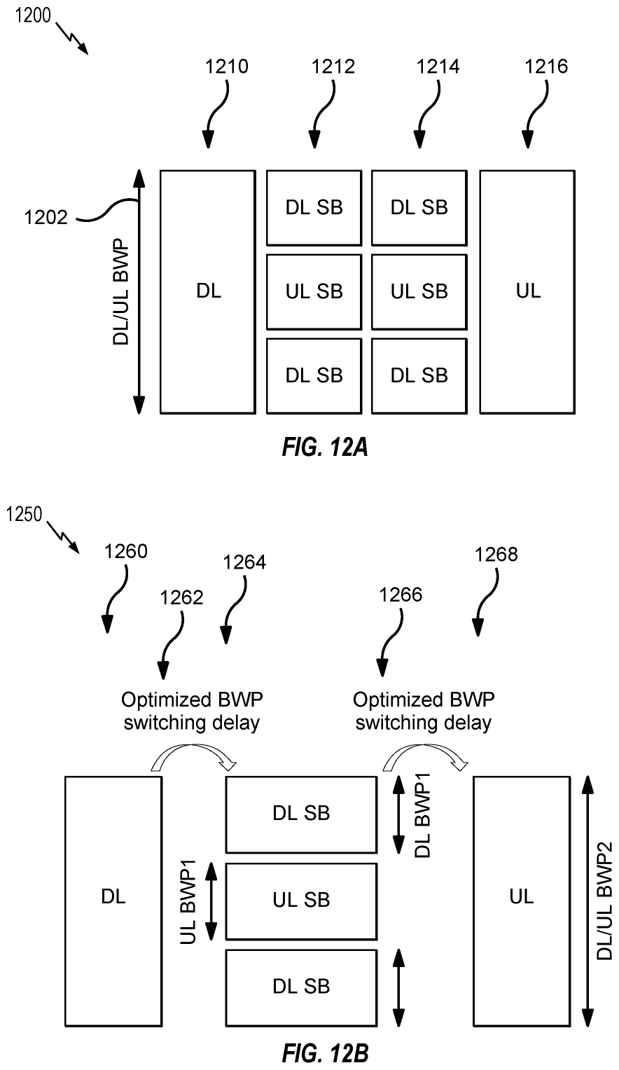

FIGS. 12A and 12B depict example timelines 1200 and 1250 of subband configurations, according to aspects of the present disclosure. FIG. 12A depicts an example timeline 1200 of subband configurations in a network in which an UL BWP or DL BWP configuration is not changed when a new subband configuration for SBFD communication is activated. The bandwidth of the active UL or DL BWP is represented at 1202. At time 1210, the subband configuration is for half duplex operation, with the entire bandwidth of the BWP configured for DL communications. At time 1212, the subband configuration is changed to include two DL subbands and an UL subband. This subband configuration is maintained at time 1214. At time 1216, the subband configuration is for half duplex operation with the entire bandwidth of the BWP configured for UL communications. FIG. 12B depicts an example timeline 1250 of subband configurations in a network in which an UL BWP or DL BWP configuration is changed when a new subband configuration for SBFD communication is activated. At time 1260, an active DL BWP is configured with the entire BWP configured for DL communications. At time 1262, a new active DL BWP and an active UL BWP are configured in the same bandwidth. At time 1264, after waiting for a BWP switching delay period, the active DL BWP and active UL BWP configured at 1262 become active, and SBFD communications can occur. This subband configuration is maintained until time 1266. At time 1266, a new active UL BWP is configured in the same bandwidth. At time 1268, after waiting for a BWP switching delay period, the active UL BWP configured at 1266 becomes active, and the subband configuration is for half duplex operation with the entire BWP configured for UL communications.

In aspects of the present disclosure, switching a BWP may entail a delay period between configuration of the new BWP and a UE being able to communicate via the new BWP. During this delay period, baseband hardware parameters of the UE may be retuned to support the new BWP.

According to aspects of the present disclosure, a network entity may inform a UE of the time and/or frequency location of subbands for SBFD operation by transmitting signaling indicating a BWP switch (e.g., from a first DL BWP to a second DL BWP or from a first UL BWP to a second UL BWP), with the BWP configurations including configuration of subbands for SBFD operation and/or no subbands to indicate switch to half duplex operation. Transmitting signaling of such a BWP switch may be an example of transmitting signaling indicating at least one of time or frequency locations of at least one UL subband and at least one DL subband for SBFD communications as shown at 806 in FIG. 8.

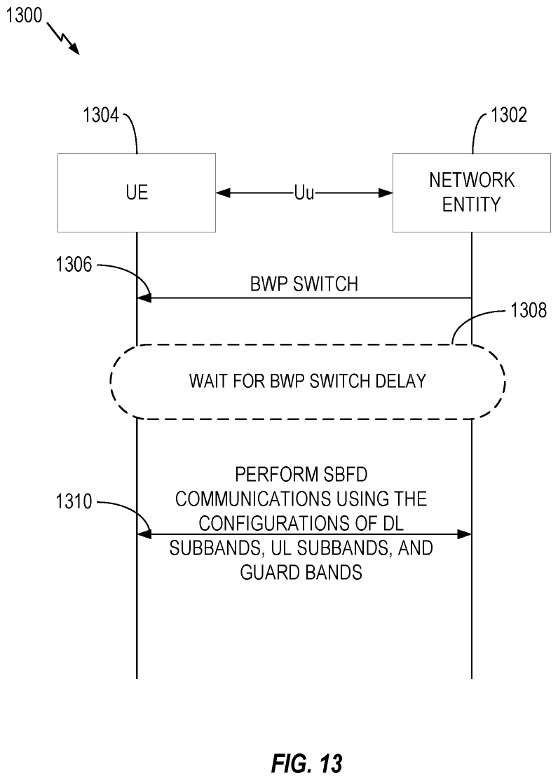

FIG. 13 depicts an example call flow 1300 for communications in a network between a network entity 1302 and a user equipment (UE) 1304. In some aspects, the network entity 1302 may be an example of the BS 102 depicted and described with respect to FIGS. 1 and 3 or a disaggregated base station depicted and described with respect to FIG. 2. Similarly, the UE 1304 may be an example of UE 104 depicted and described with respect to FIGS. 1 and 3. However, in other aspects, UE 104 may be another type of wireless communications device and BS 102 may be another type of network entity or network node, such as those described herein.

At 1306, the network entity transmits an indication for the UE to switch a BWP (e.g., from a first DL BWP to a second DL BWP or from a first UL BWP to a second UL BWP) conveying configurations of DL subbands, UL subbands, and guard bands. Optionally, at 1308, the UE and the network entity both wait for a BWP switch delay period before starting using the configurations of DL subbands, UL subbands, and guard bands for SBFD communications. At 1310, the UE and the network entity begin performing SBFD communications using the configurations of DL subbands, UL subbands, and guard bands. For example, the UE may transmit an UL signal to the network entity in an UL subband indicated in the UL BWP that was switched to. In another example, the network entity may transmit a DL signal to the UE in a DL subband indicated in the DL BWP that was switched to.

In aspects of the present disclosure, a network entity may configure a UE with a semi-static UL BWP switching pattern. The semi-static UL BWP switching pattern may include one or more BWPs configured for half duplex and SBFD patterns, and a UE configured with a semi-static UL BWP switching pattern may therefore switch between half duplex operations and SBFD operations in different time resources.

According to aspects of the present disclosure, a network entity may configure up to four UL BWPs in a semi-static UL BWP switching pattern for different half duplex and full duplex UL subband configurations, and a UE may switch between the BWP configurations based on the semi-static UL BWP switching pattern.

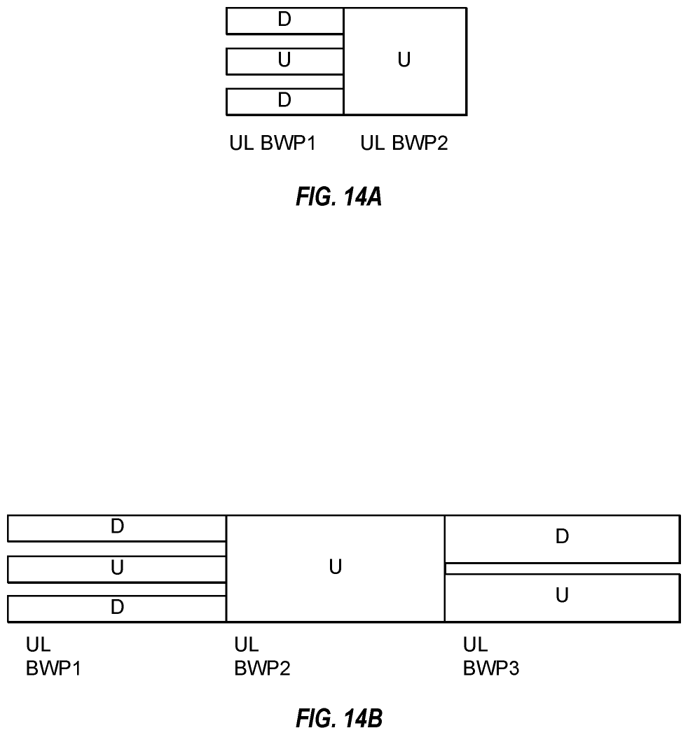

FIGS. 14A and 14B depict example semi-static UL BWP switching patterns, according to aspects of the present disclosure. A UE configured with the example semi-static UL BWP switching pattern shown in FIG. 14A switches between UL BWP1, which includes two DL subbands and an UL subband, and UL BWP2, which has no DL subbands and is therefore suitable for half duplex operations. A UE configured with the example semi-static UL BWP switching pattern shown in FIG. 14B switches between UL BWP1, which includes two DL subbands and an UL subband; UL BWP2, which has no DL subbands and is therefore suitable for half duplex operations; and UL BWP3, which has one DL subband and one UL subband of approximately equal bandwidth.

In aspects of the present disclosure, a network entity may configure a DL BWP including discontinuous groups of RBs or RB sets, with each group of RBs or RB sets representing a DL subband for SBFD communications. In such a case, the network entity may also configure an UL BWP including one or more other groups of RBs or RB sets, with each group of RBs or RB sets representing an UL subband for SBFD communications.

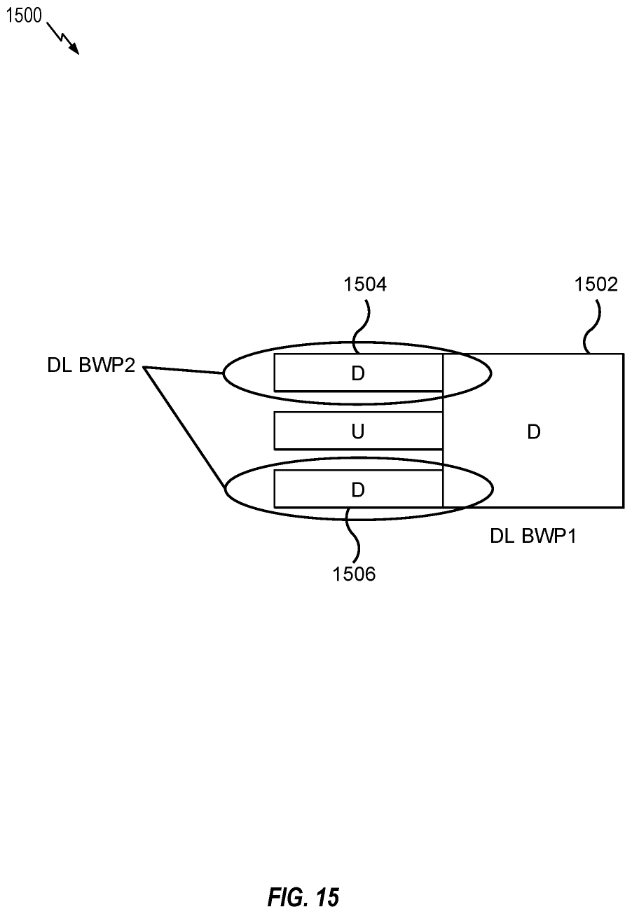

FIG. 15 depicts example DL BWPs DL BWP1 and DL BWP2, in accordance with aspects of the present disclosure. DL BWP1 includes a single group of RBs 1502. DL BWP2 includes two RB groups 1504 and 1506. A network entity configuring a UE with DL BWP2 may treat the RB group 1504 as a first DL subband for SBFD communications with the UE. The network entity may also treat the RB group 1506 as a second DL subband for SBFD communications with the UE. Similarly, the UE configured with DL BWP2 may treat the RB group 1504 as a first DL subband for SBFD communications with the network entity and treat the RB group 1506 as a second DL subband for SBFD communications with the network entity.

According to aspects of the present disclosure, a network entity may configure only one wideband channel state information (CSI) reference signal (CSI-RS) resource for a set of contiguous frequency resources configured for half duplex communications. A UE configured with that CSI-RS resource may, when configured with a DL BWP that includes non-contiguous subband frequency resources (e.g., DL BWP2 in FIG. 15) for SBFD symbols/slots, determine CSI for the non-contiguous subband frequency resources based on CSI-RS in the non-contiguous subband frequency resources that are associated with the CSI-RS resource for the contiguous frequency resource. That is, the UE may measure CSI-RS in the non-contiguous subband frequency resources while not measuring the frequency resources included in the CSI-RS resource that are not within the non-contiguous subband frequency resources. The UE may report a CSI metric for the BWP based on the measured CSI-RS in the non-contiguous subband frequency resources.

In aspects of the present disclosure, a network entity may configure only one wideband channel state information (CSI) reference signal (CSI-RS) resource for a set of contiguous frequency resources configured for half duplex communications. A UE configured with that CSI-RS resource may, when configured with a DL BWP that includes non-contiguous subband frequency resources (e.g., DL BWP2 in FIG. 15) for SBFD symbols or slots, determine CSI for each of the DL subbands based on CSI-RS in that DL subband that are associated with the CSI-RS resource for the contiguous frequency resources. That is, the UE may measure CSI-RS in each of the DL subbands while not measuring the frequency resources included in the CSI-RS resource that are not within the DL subbands. The UE may report a CSI metric for each of the DL subbands based on the measured CSI-RS in each of the DL subbands.

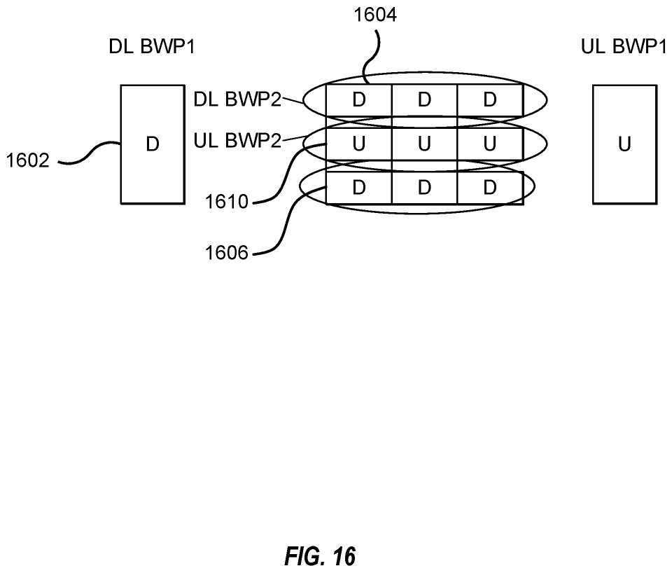

FIG. 16 depicts frequency resources of example BWPs, in accordance with aspects of the present disclosure. DL BWP1 includes a single RB group 1602. A wideband CSI-RS resource is configured for a UE across the frequencies of the RB group 1602. DL BWP2 includes two RB groups 1604 and 1606. When the UE is configured with DL BWP2 and requested to report CSI based on the CSI-RS resource, the UE may measure the CSI-RS associated with the CSI-RS resource that are within the RB groups 1604 and 1606 while not measuring CSI-RS associated with the CSI-RS resource that are within the RB group 1610. The UE may report a CSI metric for the DL BWP2 or a separate CSI metric for the DL subband on the frequency resources in RB group 1604 and for the DL subband on the frequency resources in RB group 1606.

According to aspects of the present disclosure, a network entity may configure a channel state information (CSI) reference signal (CSI-RS) resource for a DL BWP. In a communications system in which subbands may be configured for a UE without adapting a BWP configuration to match the subbands, as described herein, a UE configured with that CSI-RS resource may, when configured with one or more DL subbands that do not include all of the frequency resources of the DL BWP for SBFD symbols or slots, determine CSI for each of the DL subbands based on CSI-RS in that DL subband that are associated with the CSI-RS resource for the DL BWP. That is, the UE may measure CSI-RS in each of the DL subbands while not measuring the frequency resources included in the CSI-RS resource that are not within the DL subbands. The UE may report a CSI metric for each of the DL subbands based on the measured CSI-RS in each of the DL subbands.

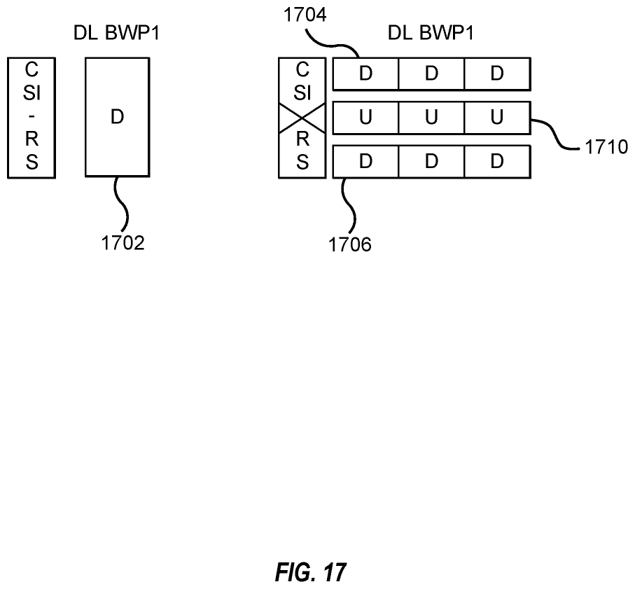

FIG. 17 depicts frequency resources of example subbands in an example DL BWP, in accordance with aspects of the present disclosure. DL BWP1 includes a single RB group 1702. A CSI-RS resource is configured for a UE across the frequencies of the DL BWP1. Later, the UE is configured with a first DL subband that includes RB group 1704 and a second DL subband that includes RB group 1706. When the UE is requested to report CSI based on the CSI-RS resource, the UE may measure the CSI-RS associated with the CSI-RS resource that are within the RB group 1704 to calculate CSI for the first DL subband while not measuring CSI-RS associated with the CSI-RS resource that are within the RB group 1710. Similarly, the UE may measure the CSI-RS associated with the CSI-RS resource that are within the RB group 1706 to calculate CSI for the second DL subband while not measuring CSI-RS associated with the CSI-RS resource that are within the RB group 1710. The UE may report a CSI metric for each of the first DL subband and the second DL subband.

In aspects of the present disclosure, a network entity may configure a sounding reference signal (SRS) resource for an UL BWP. In a communications system in which subbands may be configured for a UE without adapting a BWP configuration to match the subbands, as described herein, a UE configured with that SRS resource may, when configured with one or more UL subbands that do not include all of the frequency resources of the UL BWP for SBFD symbols or slots, transmit SRS for each of the UL subbands based on SRS in that UL subband that are associated with the SRS resource for the UL BWP. That is, the UE may transmit SRS in each of the UL subbands while not transmitting SRS in the frequency resources included in the SRS resource that are not within the UL subbands.

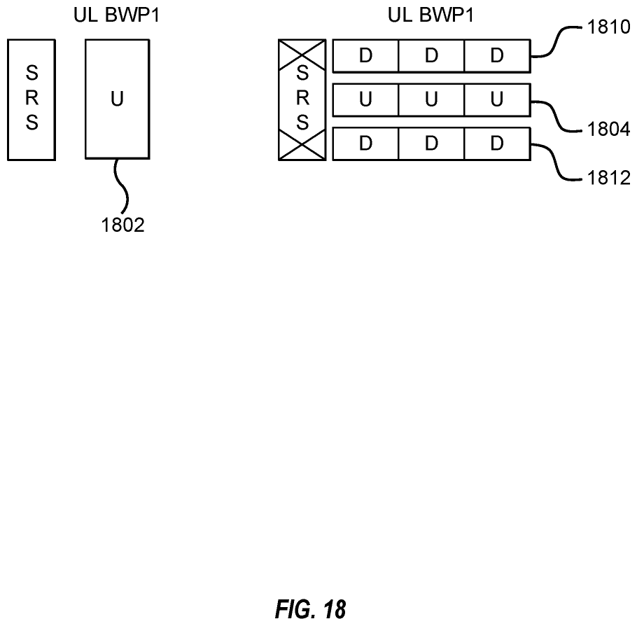

FIG. 18 depicts frequency resources of example subbands in an example UL BWP, in accordance with aspects of the present disclosure. UL BWP1 includes a single RB group 1802. An SRS resource is configured for a UE across the frequencies of the UL BWP1. Later, the UE is configured with a first UL subband that includes RB group 1804, a first DL subband that includes RB group 1810, and a second DL subband that includes RB group 1812. When the UE is requested to transmit SRS based on the SRS resource, the UE may transmit the SRS associated with the SRS resource that are within the RB group 1804 while not transmitting SRS associated with the SRS resource that are within the RB group 1810. Similarly, the UE may transmit the SRS associated with the SRS resource that are within the RB group 1804 while not transmitting SRS associated with the SRS resource that are within the RB group 1812. A network entity may measure the SRS associated with the SRS resource that are within the RB group 1804 while not measuring SRS associated with the SRS resource that are within the RB groups 1810 and 1812.

### Example Operations of a User Equipment

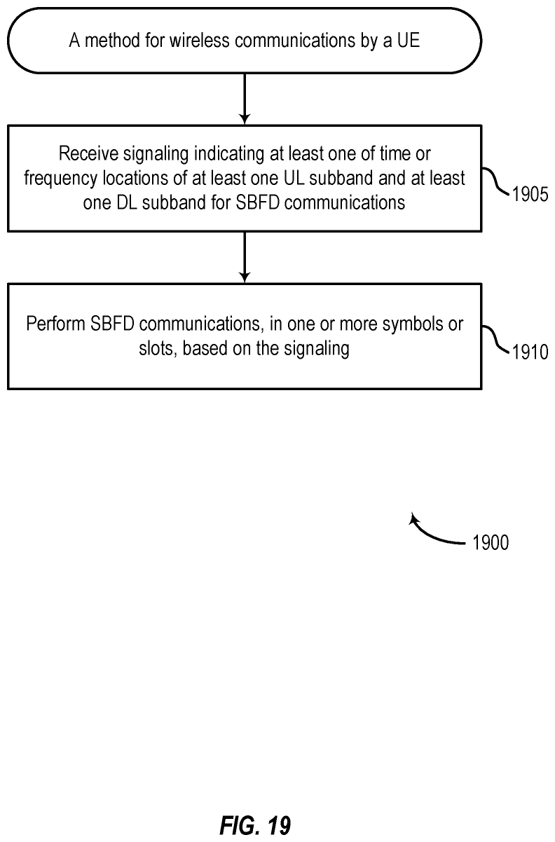

FIG. 19 shows an example of a method 1900 for wireless communications by a UE, such as a UE 104 of FIGS. 1 and 3.

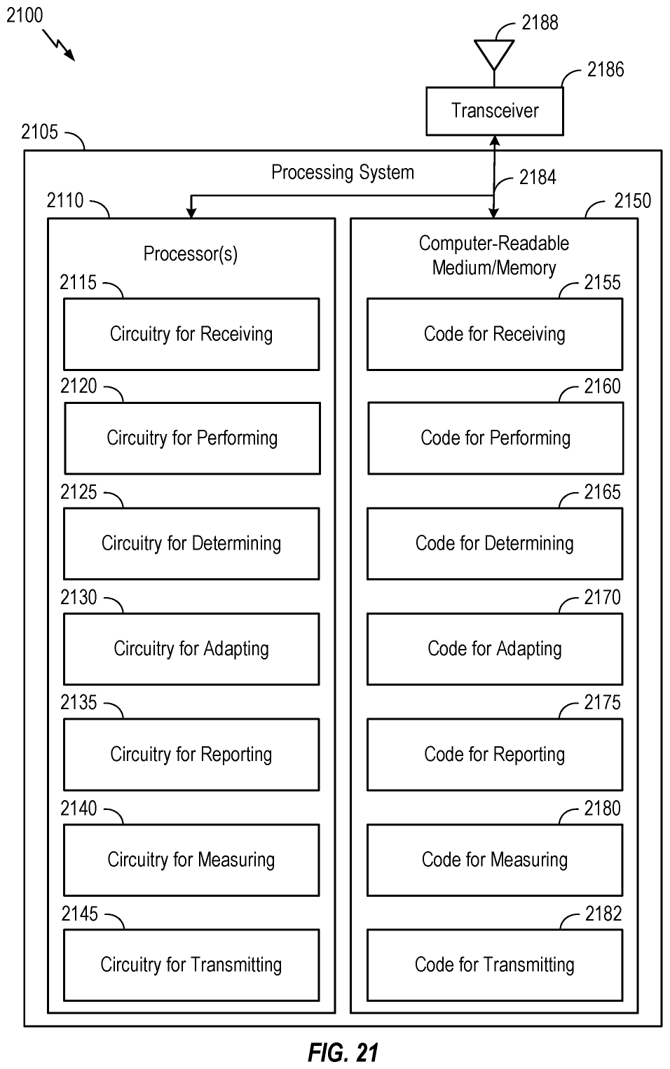

Method 1900 begins at step 1905 with receiving signaling indicating at least one of time or frequency locations of at least one UL subband and at least one DL subband for SBFD communications. In some cases, the operations of this step refer to, or may be performed by, circuitry for receiving and/or code for receiving as described with reference to FIG. 21.

Method 1900 then proceeds to step 1910 with performing SBFD communications, in one or more symbols or slots, based on the signaling. In some cases, the operations of this step refer to, or may be performed by, circuitry for performing and/or code for performing as described with reference to FIG. 21.

In some aspects, the signaling comprises at least one of a MAC-CE or a DCI.

In some aspects, the signaling indicates: a starting RB index for each DL subband of the at least one DL subband; at least one of an ending RB index or an allocation bandwidth for each DL subband of the at least one DL subband; a starting RB index for each UL subband of the at least one UL subband; and at least one of an ending RB index or an allocation bandwidth for each UL subband of the at least one UL subband.

In some aspects, the signaling further indicates an offset value indicating a start time when the signaling becomes effective.

In some aspects, the signaling further indicates a symbol and slot configuration pattern, comprising: a first indication of a set of slots during which the signaling is effective; and a second indication of a set of symbols in each slot of the set of slots during which the signaling is effective.

In some aspects, the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

In some aspects, the signaling comprises: one or more indices of RB sets included in each DL subband of the at least one DL subband; and one or more indices of RB sets included in each UL subband of the at least one UL subband.

In some aspects, the signaling further indicates an offset value indicating a start time when the signaling becomes effective.

In some aspects, the signaling further indicates a symbol and slot configuration pattern, comprising: a first indication of a set of slots during which the signaling is effective; and a second indication of a set of symbols in each slot of the set of slots during which the signaling is effective.

In some aspects, the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

In some aspects, the signaling indicates: an explicit subband frequency configuration pattern indicating a relationship of the frequency location of the at least one DL subband to the frequency location of the at least one UL subband; a starting RB index of a GB having a frequency between the frequency location of the at least one DL subband and the frequency location of the at least one UL subband; and at least one of an ending RB index or an allocation bandwidth of the GB.

In some aspects, the signaling further indicates: a frequency location of an additional DL subband of the at least one DL subband, wherein the explicit subband frequency configuration pattern further indicates a relationship of the frequency location of the additional DL subband to the frequency location of the at least one UL subband; a starting RB index of an additional GB having a frequency between the frequency location of the additional DL subband and the frequency location of the at least one UL subband; and at least one of an ending RB index or an allocation bandwidth of the additional GB.

In some aspects, the signaling further indicates an offset value indicating a start time when the configuration becomes effective.

In some aspects, the signaling further indicates a symbol and slot configuration pattern, comprising: a first indication of a set of slots during which the signaling is effective; and a second indication of a set of symbols in each slot of the set of slots during which the signaling is effective.

In some aspects, the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

In some aspects, the signaling further indicates: a frequency location of an additional UL subband of the at least one UL subband, wherein the explicit subband frequency configuration pattern further indicates a relationship of the frequency location of the additional UL subband to the frequency location of the at least one DL subband; a starting RB index of an additional GB having a frequency between the frequency location of the additional UL subband and the frequency location of the at least one DL subband; and at least one of an ending RB index or an allocation bandwidth of the additional GB.

In some aspects, the signaling further indicates an offset value indicating a start time when the signaling becomes effective.

In some aspects, the signaling further indicates a symbol and slot configuration pattern, comprising: a first indication of a set of slots during which the signaling is effective; and a second indication of a set of symbols in each slot of the set of slots during which the signaling is effective.

In some aspects, the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

In some aspects, the signaling further indicates: a starting RB index of a first edge GB, wherein the starting RB includes a first edge frequency of the CC; at least one of an ending RB index or a bandwidth of the first edge GB; a starting RB index of a second edge GB having a frequency higher than the frequency of the at least one DL subband and the frequency of the at least one UL subband; and at least one of an ending RB index or a bandwidth of the second edge GB, wherein the ending RB or the bandwidth of the second edge GB includes a second edge frequency of the CC.

In some aspects, the signaling indicates: a starting RB index of a GB having a frequency between the frequency location of the at least one DL subband and the frequency location of the at least one UL subband; at least one of an ending RB index or an allocation bandwidth of the GB; and a starting RB index and at least one of an ending RB index or an allocation bandwidth of the GB of the at least one or more DL subbands or the at least one UL subband.

In some aspects, the signaling further indicates an offset value indicating a start time when the signaling becomes effective.

In some aspects, the signaling further indicates a symbol and slot configuration pattern, comprising: a first indication of a set of slots during which the signaling is effective; and a second indication of a set of symbols in each slot of the set of slots during which the signaling is effective.

In some aspects, the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

In some aspects, the method 1900 further includes determining, based on a pre-defined rule, not to adapt an active UL BWP or an active DL BWP in response to the signaling. In some cases, the operations of this step refer to, or may be performed by, circuitry for determining and/or code for determining as described with reference to FIG. 21.

In some aspects, the method 1900 further includes adapting at least one of an active UL bandwidth part or an active DL bandwidth part in response to the signaling. In some cases, the operations of this step refer to, or may be performed by, circuitry for adapting and/or code for adapting as described with reference to FIG. 21.

In some aspects, the method 1900 further includes receiving a BWP switching signal, wherein performing the SBFD communications comprises waiting until receiving the BWP switching signal before performing the SBFD communications, in one or more symbols or slots, based on the signaling. In some cases, the operations of this step refer to, or may be performed by, circuitry for receiving and/or code for receiving as described with reference to FIG. 21.

In some aspects, the signaling indicates a BWP switch to a first BWP; and the frequency location of the at least one uplink subband or the frequency location of the at least one downlink subband are indicated in a BWP configuration for the first BWP.

In some aspects, the first BWP comprises a first UL BWP that indicates the frequency location of the at least one UL subband. In some aspects, the method 1900 further includes: receiving a configuration of a semi-static UL BWP switching pattern indicating the BWP configuration for the first UL BWP and a BWP configuration for at least one second UL BWP; and switching from the at least one second UL BWP to the first UL BWP in response to the signaling and based on the semi-static UL BWP switching pattern. In some cases, the operations of this step refer to, or may be performed by, circuitry for receiving and/or code for receiving as described with reference to FIG. 21.

In some aspects, the signaling indicates a first DL BWP configuration comprising the at least one DL subband and another DL subband, wherein the at least one DL subband and the other DL subband are in non-contiguous frequency bands.

In some aspects, the method 1900 further includes receiving a configuration of a CSI-RS transmitted via a bandwidth of the CC, wherein the CSI-RS has a CSI-RS resource identifier. In some cases, the operations of this step refer to, or may be performed by, circuitry for receiving and/or code for receiving as described with reference to FIG. 21.

In some aspects, the method 1900 further includes receiving a command to report channel state information for the at least one DL subband and the other DL subband, associated with the CSI-RS resource identifier. In some cases, the operations of this step refer to, or may be performed by, circuitry for receiving and/or code for receiving as described with reference to FIG. 21.

In some aspects, the method 1900 further includes reporting a CSI metric in a CSI report for the at least one DL subband and the other DL subband based on CSI-RS within the at least one DL subband and the other DL subband that correspond to the CSI-RS within the CC associated with the CSI-RS resource identifier. In some cases, the operations of this step refer to, or may be performed by, circuitry for reporting and/or code for reporting as described with reference to FIG. 21.

In some aspects, the method 1900 further includes measuring CSI-RS associated with the CSI-RS resource identifier within the at least one DL subband and the other DL subband, wherein the CSI metric is calculated based on the CSI-RS associated with the CSI-RS resource identifier within the at least one DL subband and the other DL subband and not based on CSI-RS associated with the CSI-RS resource identifier outside of the at least one DL subband and the other DL subband. In some cases, the operations of this step refer to, or may be performed by, circuitry for measuring and/or code for measuring as described with reference to FIG. 21.

In some aspects, the UE determines the CSI-RS to measure based on the first DL BWP configuration.

In some aspects, the signaling indicates the frequency locations of the at least one DL subband and another DL subband, wherein the at least one DL subband and the other DL subband are in non-contiguous frequency bands.

In some aspects, the method 1900 further includes receiving a DL BWP configuration including a configuration of a CSI-RS, wherein frequency locations of the DL BWP include the frequency locations of the at least one DL subband and the other DL subband, wherein the CSI-RS has a CSI-RS resource identifier (CRI). In some cases, the operations of this step refer to, or may be performed by, circuitry for receiving and/or code for receiving as described with reference to FIG. 21.

In some aspects, the method 1900 further includes receiving a command to report channel state information associated with the CSI-RS resource identifier. In some cases, the operations of this step refer to, or may be performed by, circuitry for receiving and/or code for receiving as described with reference to FIG. 21.

In some aspects, the method 1900 further includes reporting a CSI metric in a CSI report for the at least one DL subband and the other DL subband based on CSI-RS within the at least one DL subband and the other DL subband that correspond to the CSI-RS associated with the CSI-RS resource identifier. In some cases, the operations of this step refer to, or may be performed by, circuitry for reporting and/or code for reporting as described with reference to FIG. 21.

In some aspects, the method 1900 further includes measuring CSI-RS associated with the CSI-RS resource identifier within the at least one DL subband and the other DL subband, wherein the CSI metric is calculated based on the CSI-RS associated with the CSI-RS resource identifier within the at least one DL subband and the other DL subband and not based on CSI-RS associated with the CSI-RS resource identifier outside of the at least one DL subband and the other DL subband. In some cases, the operations of this step refer to, or may be performed by, circuitry for measuring and/or code for measuring as described with reference to FIG. 21.

In some aspects, the method 1900 further includes receiving a configuration of an UL BWP including a configuration of a SRS to be transmitted by the UE via a bandwidth of the UL BWP, wherein frequency locations of the UL BWP include the frequency locations of the at least one DL subband. In some cases, the operations of this step refer to, or may be performed by, circuitry for receiving and/or code for receiving as described with reference to FIG. 21.

In some aspects, the method 1900 further includes receiving a command to transmit SRS. In some cases, the operations of this step refer to, or may be performed by, circuitry for receiving and/or code for receiving as described with reference to FIG. 21.

In some aspects, the method 1900 further includes transmitting SRS in the at least one UL subband based on the configuration of the UL BWP while not transmitting SRS on frequency locations of the BWP that are not included in the UL subband. In some cases, the operations of this step refer to, or may be performed by, circuitry for transmitting and/or code for transmitting as described with reference to FIG. 21.

In one aspect, method 1900, or any aspect related to it, may be performed by an apparatus, such as communications device 2100 of FIG. 21, which includes various components operable, configured, or adapted to perform the method 1900. Communications device 2100 is described below in further detail.

Note that FIG. 19 is just one example of a method, and other methods including fewer, additional, or alternative steps are possible consistent with this disclosure.

### Example Operations of a Network Entity

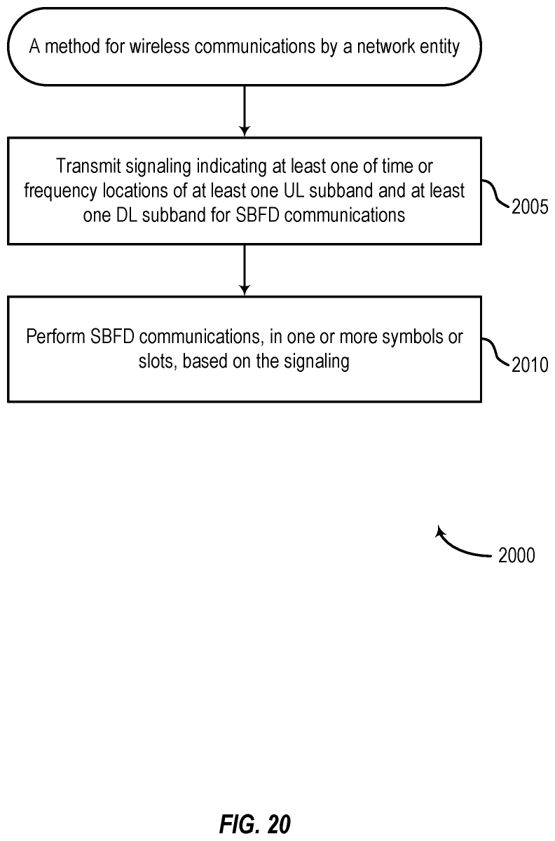

FIG. 20 shows an example of a method 2000 for wireless communications by a network entity, such as a BS 102 of FIGS. 1 and 3, or a disaggregated base station as discussed with respect to FIG. 2.

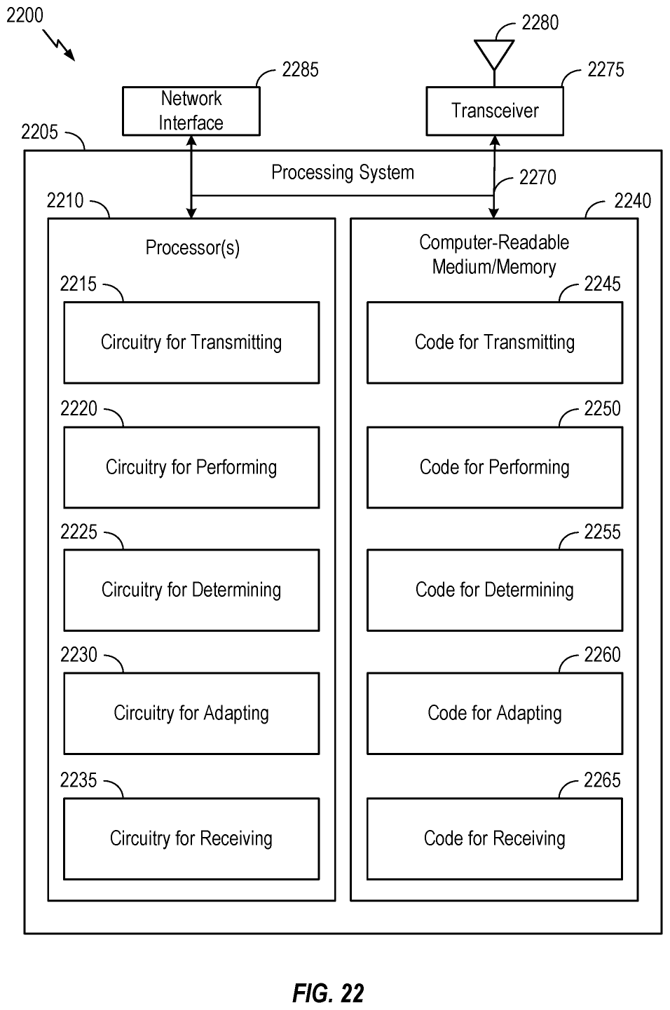

Method 2000 begins at step 2005 with transmitting signaling indicating at least one of time or frequency locations of at least one UL subband and at least one DL subband for SBFD communications. In some cases, the operations of this step refer to, or may be performed by, circuitry for transmitting and/or code for transmitting as described with reference to FIG. 22.

Method 2000 then proceeds to step 2010 with performing SBFD communications, in one or more symbols or slots, based on the signaling. In some cases, the operations of this step refer to, or may be performed by, circuitry for performing and/or code for performing as described with reference to FIG. 22.

In some aspects, the signaling comprises at least one of a MAC-CE or a DCI.

In some aspects, the signaling indicates: a starting RB index for each DL subband of the at least one DL subband; at least one of an ending RB index or an allocation bandwidth for each DL subband of the at least one DL subband; a starting RB index for each UL subband of the at least one UL subband; and at least one of an ending RB index or an allocation bandwidth for each UL subband of the at least one UL subband.

In some aspects, the signaling further indicates an offset value indicating a start time when the signaling becomes effective.

In some aspects, the signaling further indicates a symbol and slot configuration pattern, comprising: a first indication of a set of slots during which the signaling is effective; and a second indication of a set of symbols in each slot of the set of slots during which the signaling is effective.

In some aspects, the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

In some aspects, the signaling comprises: one or more indices of RB sets included in each DL subband of the at least one DL subband; and one or more indices of RB sets included in each UL subband of the at least one UL subband.

In some aspects, the signaling further indicates an offset value indicating a start time when the signaling becomes effective.

In some aspects, the signaling further indicates a symbol and slot configuration pattern, comprising: a first indication of a set of slots during which the signaling is effective; and a second indication of a set of symbols in each slot of the set of slots during which the signaling is effective.

In some aspects, the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

In some aspects, the signaling indicates: an explicit subband frequency configuration pattern indicating a relationship of the frequency location of the at least one DL subband to the frequency location of the at least one UL subband; a starting RB index of a GB having a frequency between the frequency location of the at least one DL subband and the frequency location of the at least one UL subband; and at least one of an ending RB index or an allocation bandwidth of the GB.

In some aspects, the signaling further indicates: a frequency location of an additional DL subband of the at least one DL subband, wherein the explicit subband frequency configuration pattern further indicates a relationship of the frequency location of the additional DL subband to the frequency location of the at least one UL subband; a starting RB index of an additional GB having a frequency between the frequency location of the additional DL subband and the frequency location of the at least one UL subband; and at least one of an ending RB index or an allocation bandwidth of the additional GB.

In some aspects, the signaling further indicates an offset value indicating a start time when the configuration becomes effective.

In some aspects, the signaling further indicates a symbol and slot configuration pattern, comprising: a first indication of a set of slots during which the signaling is effective; and a second indication of a set of symbols in each slot of the set of slots during which the signaling is effective.

In some aspects, the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

In some aspects, the signaling further indicates: a frequency location of an additional UL subband of the at least one UL subband, wherein the explicit subband frequency configuration pattern further indicates a relationship of the frequency location of the additional UL subband to the frequency location of the at least one DL subband; a starting RB index of an additional GB having a frequency between the frequency location of the additional UL subband and the frequency location of the at least one DL subband; and at least one of an ending RB index or an allocation bandwidth of the additional GB.

In some aspects, the signaling further indicates an offset value indicating a start time when the signaling becomes effective.

In some aspects, the signaling further indicates a symbol and slot configuration pattern, comprising: a first indication of a set of slots during which the signaling is effective; and a second indication of a set of symbols in each slot of the set of slots during which the signaling is effective.

In some aspects, the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

In some aspects, the signaling further indicates: a starting RB index of a first edge GB, wherein the starting RB includes a first edge frequency of the CC; at least one of an ending RB index or a bandwidth of the first edge GB; a starting RB index of a second edge GB having a frequency higher than the frequency of the at least one DL subband and the frequency of the at least one UL subband; and at least one of an ending RB index or a bandwidth of the second edge GB, wherein the ending RB or the bandwidth of the second edge GB includes a second edge frequency of the CC.

In some aspects, the signaling indicates: a starting RB index of a GB having a frequency between the frequency location of the at least one DL subband and the frequency location of the at least one UL subband; at least one of an ending RB index or an allocation bandwidth of the GB; and a direction of the at least one DL subband or the at least one UL subband.

In some aspects, the signaling further indicates an offset value indicating a start time when the signaling becomes effective.

In some aspects, the signaling further indicates a symbol and slot configuration pattern, comprising: a first indication of a set of slots during which the signaling is effective; and a second indication of a set of symbols in each slot of the set of slots during which the signaling is effective.

In some aspects, the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

In some aspects, the method 2000 further includes determining, based on a pre-defined rule, not to adapt an active UL BWP or an active DL BWP in response to the signaling. In some cases, the operations of this step refer to, or may be performed by, circuitry for determining and/or code for determining as described with reference to FIG. 22.

In some aspects, the method 2000 further includes adapting at least one of an active UL bandwidth part or an active DL bandwidth part in response to the signaling. In some cases, the operations of this step refer to, or may be performed by, circuitry for adapting and/or code for adapting as described with reference to FIG. 22.

In some aspects, the method 2000 further includes transmitting a BWP switching signal, wherein performing the SBFD communications comprises waiting until transmitting the BWP switching signal before performing the SBFD communications, in one or more symbols or slots, based on the signaling. In some cases, the operations of this step refer to, or may be performed by, circuitry for transmitting and/or code for transmitting as described with reference to FIG. 22.

In some aspects, the signaling indicates a BWP switch to a first BWP; and the frequency location of the at least one uplink subband or the frequency location of the at least one downlink subband are indicated in a BWP configuration for the first BWP.

In some aspects, the first BWP comprises a first UL BWP that indicates the frequency location of the at least one UL subband. In some aspects, the method 2000 further includes: transmitting a configuration of a semi-static UL BWP switching pattern indicating the BWP configuration for the first UL BWP and a BWP configuration for at least one second UL BWP, wherein the signaling indicates a switch based on the semi-static UL BWP switching pattern. In some cases, the operations of this step refer to, or may be performed by, circuitry for transmitting and/or code for transmitting as described with reference to FIG. 22.

In some aspects, the signaling indicates a first DL BWP configuration comprising the at least one DL subband and another DL subband, wherein the at least one DL subband and the other DL subband are in non-contiguous frequency bands.

In some aspects, the method 2000 further includes transmitting a configuration of a CSI-RS transmitted via a bandwidth of the CC, wherein the CSI-RS has a CSI-RS resource identifier. In some cases, the operations of this step refer to, or may be performed by, circuitry for transmitting and/or code for transmitting as described with reference to FIG. 22.

In some aspects, the method 2000 further includes transmitting a command to report channel state information for the at least one DL subband and the other DL subband, associated with the CSI-RS resource identifier. In some cases, the operations of this step refer to, or may be performed by, circuitry for transmitting and/or code for transmitting as described with reference to FIG. 22.

In some aspects, the method 2000 further includes receiving a CSI metric in a CSI report for the at least one DL subband and the other DL subband based on CSI-RS within the at least one DL subband and the other DL subband that correspond to the CSI-RS within the CC associated with the CSI-RS resource identifier. In some cases, the operations of this step refer to, or may be performed by, circuitry for receiving and/or code for receiving as described with reference to FIG. 22.

In some aspects, the CSI metric is calculated based on the CSI-RS associated with the CSI-RS resource identifier within the at least one DL subband and the other DL subband and not based on CSI-RS associated with the CSI-RS resource identifier outside of the at least one DL subband and the other DL subband.

In some aspects, the signaling indicates the frequency locations of the at least one DL subband and another DL subband, wherein the at least one DL subband and the other DL subband are in non-contiguous frequency bands.

In some aspects, the method 2000 further includes transmitting a DL BWP configuration including a configuration of a CSI-RS, wherein frequency locations of the DL BWP includes the frequency locations of the at least one DL subband and the other DL subband, wherein the CSI-RS has a CSI-RS resource identifier. In some cases, the operations of this step refer to, or may be performed by, circuitry for transmitting and/or code for transmitting as described with reference to FIG. 22.

In some aspects, the method 2000 further includes transmitting a command to report channel state information associated with the CSI-RS resource identifier. In some cases, the operations of this step refer to, or may be performed by, circuitry for transmitting and/or code for transmitting as described with reference to FIG. 22.

In some aspects, the method 2000 further includes receiving a CSI metric in a CSI report for the at least one DL subband and the other DL subband based on CSI-RS within the at least one DL subband and the other DL subband that correspond to the CSI-RS associated with the CSI-RS resource identifier. In some cases, the operations of this step refer to, or may be performed by, circuitry for receiving and/or code for receiving as described with reference to FIG. 22.

In some aspects, the CSI metric is calculated based on the CSI-RS associated with the CSI-RS resource identifier within the at least one DL subband and the other DL subband and not based on CSI-RS associated with the CSI-RS resource identifier outside of the at least one DL subband and the other DL subband.

In some aspects, the method 2000 further includes transmitting a configuration of an UL BWP including a configuration of a SRS to be transmitted via a bandwidth of the UL BWP, wherein frequency locations of the UL BWP include the frequency locations of the at least one DL subband. In some cases, the operations of this step refer to, or may be performed by, circuitry for transmitting and/or code for transmitting as described with reference to FIG. 22.

In some aspects, the method 2000 further includes transmitting a command to transmit SRS. In some cases, the operations of this step refer to, or may be performed by, circuitry for transmitting and/or code for transmitting as described with reference to FIG. 22.

In some aspects, the method 2000 further includes receiving SRS in the UL subband based on the configuration of the UL subband configuration while not receiving SRS on frequency locations of the BWP that are not included in the UL subband. In some cases, the operations of this step refer to, or may be performed by, circuitry for receiving and/or code for receiving as described with reference to FIG. 22.

In one aspect, method 2000, or any aspect related to it, may be performed by an apparatus, such as communications device 2200 of FIG. 22, which includes various components operable, configured, or adapted to perform the method 2000. Communications device 2200 is described below in further detail.

Note that FIG. 20 is just one example of a method, and other methods including fewer, additional, or alternative steps are possible consistent with this disclosure.

### Example Communications Devices

FIG. 21 depicts aspects of an example communications device 2100. In some aspects, communications device 2100 is a user equipment, such as a UE 104 described above with respect to FIGS. 1 and 3.

The communications device 2100 includes a processing system 2105 coupled to the transceiver 2186 (e.g., a transmitter and/or a receiver). The transceiver 2186 is configured to transmit and receive signals for the communications device 2100 via the antenna 2188, such as the various signals as described herein. The processing system 2105 may be configured to perform processing functions for the communications device 2100, including processing signals received and/or to be transmitted by the communications device 2100.

The processing system 2105 includes one or more processors 2110. In various aspects, the one or more processors 2110 may be representative of one or more of receive processor 358, transmit processor 364, TX MIMO processor 366, and/or controller/processor 380, as described with respect to FIG. 3. The one or more processors 2110 are coupled to a computer-readable medium/memory 2150 via a bus 2184. In certain aspects, the computer-readable medium/memory 2150 is configured to store instructions (e.g., computer-executable code) that when executed by the one or more processors 2110, cause the one or more processors 2110 to perform the method 1900 described with respect to FIG. 19, or any aspect related to it. Note that reference to a processor performing a function of communications device 2100 may include one or more processors 2110 performing that function of communications device 2100.

In the depicted example, computer-readable medium/memory 2150 stores code (e.g., executable instructions), such as code for receiving 2155, code for performing 2160, code for determining 2165, code for adapting 2170, code for reporting 2175, code for measuring 2180, and code for transmitting 2182. Processing of the code for receiving 2155, code for performing 2160, code for determining 2165, code for adapting 2170, code for reporting 2175, code for measuring 2180, and code for transmitting 2182 may cause the communications device 2100 to perform the method 1900 described with respect to FIG. 19, or any aspect related to it.

The one or more processors 2110 include circuitry configured to implement (e.g., execute) the code stored in the computer-readable medium/memory 2150, including circuitry such as circuitry for receiving 2115, circuitry for performing 2120, circuitry for determining 2125, circuitry for adapting 2130, circuitry for reporting 2135, circuitry for measuring 2140, and circuitry for transmitting 2145. Processing with circuitry for receiving 2115, circuitry for performing 2120, circuitry for determining 2125, circuitry for adapting 2130, circuitry for reporting 2135, circuitry for measuring 2140, and circuitry for transmitting 2145 may cause the communications device 2100 to perform the method 1900 described with respect to FIG. 19, or any aspect related to it.

Various components of the communications device 2100 may provide means for performing the method 1900 described with respect to FIG. 19, or any aspect related to it. For example, means for transmitting, sending, or outputting for transmission may include transceivers 354 and/or antenna(s) 352 of the UE 104 illustrated in FIG. 3 and/or the transceiver 2186 and the antenna 2188 of the communications device 2100 in FIG. 21. Means for receiving or obtaining may include transceivers 354 and/or antenna(s) 352 of the UE 104 illustrated in FIG. 3 and/or the transceiver 2186 and the antenna 2188 of the communications device 2100 in FIG. 21.

FIG. 22 depicts aspects of an example communications device 2200. In some aspects, communications device 2200 is a network entity, such as a BS 102 of FIGS. 1 and 3, or a disaggregated base station as discussed with respect to FIG. 2.

The communications device 2200 includes a processing system 2205 coupled to the transceiver 2275 (e.g., a transmitter and/or a receiver) and/or a network interface 2285. The transceiver 2275 is configured to transmit and receive signals for the communications device 2200 via the antenna 2280, such as the various signals as described herein. The network interface 2285 is configured to obtain and send signals for the communications device 2200 via communication link(s), such as a backhaul link, midhaul link, and/or fronthaul link as described herein, such as with respect to FIG. 2. The processing system 2205 may be configured to perform processing functions for the communications device 2200, including processing signals received and/or to be transmitted by the communications device 2200.

The processing system 2205 includes one or more processors 2210. In various aspects, one or more processors 2210 may be representative of one or more of receive processor 338, transmit processor 320, TX MIMO processor 330, and/or controller/processor 340, as described with respect to FIG. 3. The one or more processors 2210 are coupled to a computer-readable medium/memory 2240 via a bus 2270. In certain aspects, the computer-readable medium/memory 2240 is configured to store instructions (e.g., computer-executable code) that when executed by the one or more processors 2210, cause the one or more processors 2210 to perform the method 2000 described with respect to FIG. 20, or any aspect related to it. Note that reference to a processor of communications device 2200 performing a function may include one or more processors 2210 of communications device 2200 performing that function.

In the depicted example, the computer-readable medium/memory 2240 stores code (e.g., executable instructions), such as code for transmitting 2245, code for performing 2250, code for determining 2255, code for adapting 2260, and code for receiving 2265. Processing of the code for transmitting 2245, code for performing 2250, code for determining 2255, code for adapting 2260, and code for receiving 2265 may cause the communications device 2200 to perform the method 2000 described with respect to FIG. 20, or any aspect related to it.

The one or more processors 2210 include circuitry configured to implement (e.g., execute) the code stored in the computer-readable medium/memory 2240, including circuitry such as circuitry for transmitting 2215, circuitry for performing 2220, circuitry for determining 2225, circuitry for adapting 2230, and circuitry for receiving 2235. Processing with circuitry for transmitting 2215, circuitry for performing 2220, circuitry for determining 2225, circuitry for adapting 2230, and circuitry for receiving 2235 may cause the communications device 2200 to perform the method 2000 as described with respect to FIG. 20, or any aspect related to it.

Various components of the communications device 2200 may provide means for performing the method 2000 as described with respect to FIG. 20, or any aspect related to it. Means for transmitting, sending, or outputting for transmission may include transceivers 332 and/or antenna(s) 334 of the BS 102 illustrated in FIG. 3 and/or the transceiver 2275 and the antenna 2280 of the communications device 2200 in FIG. 22. Means for receiving or obtaining may include transceivers 332 and/or antenna(s) 334 of the BS 102 illustrated in FIG. 3 and/or the transceiver 2275 and the antenna 2280 of the communications device 2200 in FIG. 22.

### Example Clauses

Implementation examples are described in the following numbered clauses:

Clause 1: A method for wireless communications by a UE, comprising: receiving signaling indicating at least one of time or frequency locations of at least one UL subband and at least one DL subband for SBFD communications; and performing SBFD communications, in one or more symbols or slots, based on the signaling.

Clause 2: The method of Clause 1, wherein the signaling comprises at least one of a MAC-CE or a DCI.

Clause 3: The method of any one of Clauses 1 and 2, wherein the signaling indicates: a starting RB index for each DL subband of the at least one DL subband; at least one of an ending RB index or an allocation bandwidth for each DL subband of the at least one DL subband; a starting RB index for each UL subband of the at least one UL subband; and at least one of an ending RB index or an allocation bandwidth for each UL subband of the at least one UL subband.

Clause 4: The method of Clause 3, wherein the signaling further indicates an offset value indicating a start time when the signaling becomes effective.

Clause 5: The method of Clause 3, wherein the signaling further indicates a symbol and slot configuration pattern, comprising: a first indication of a set of slots during which the signaling is effective; and a second indication of a set of symbols in each slot of the set of slots during which the signaling is effective.

Clause 6: The method of Clause 5, wherein the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

Clause 7: The method of any one of Clauses 1-6, wherein the signaling comprises: one or more indices of RB sets included in each DL subband of the at least one DL subband; and one or more indices of RB sets included in each UL subband of the at least one UL subband.

Clause 8: The method of Clause 7, wherein the signaling further indicates an offset value indicating a start time when the signaling becomes effective.

Clause 9: The method of Clause 7, wherein the signaling further indicates a symbol and slot configuration pattern, comprising: a first indication of a set of slots during which the signaling is effective; and a second indication of a set of symbols in each slot of the set of slots during which the signaling is effective.

Clause 10: The method of Clause 9, wherein the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

Clause 11: The method of any one of Clauses 1-10, wherein the signaling indicates: an explicit subband frequency configuration pattern indicating a relationship of the frequency location of the at least one DL subband to the frequency location of the at least one UL subband; a starting RB index of a GB having a frequency between the frequency location of the at least one DL subband and the frequency location of the at least one UL subband; and at least one of an ending RB index or an allocation bandwidth of the GB.

Clause 12: The method of Clause 11, wherein the signaling further indicates: a frequency location of an additional DL subband of the at least one DL subband, wherein the explicit subband frequency configuration pattern further indicates a relationship of the frequency location of the additional DL subband to the frequency location of the at least one UL subband; a starting RB index of an additional GB having a frequency between the frequency location of the additional DL subband and the frequency location of the at least one UL subband; and at least one of an ending RB index or an allocation bandwidth of the additional GB.

Clause 13: The method of Clause 12, wherein the signaling further indicates an offset value indicating a start time when the configuration becomes effective.

Clause 14: The method of Clause 12, wherein the signaling further indicates a symbol and slot configuration pattern, comprising: a first indication of a set of slots during which the signaling is effective; and a second indication of a set of symbols in each slot of the set of slots during which the signaling is effective.

Clause 15: The method of Clause 14, wherein the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

Clause 16: The method of Clause 11, wherein the signaling further indicates: a frequency location of an additional UL subband of the at least one UL subband, wherein the explicit subband frequency configuration pattern further indicates a relationship of the frequency location of the additional UL subband to the frequency location of the at least one DL subband; a starting RB index of an additional GB having a frequency between the frequency location of the additional UL subband and the frequency location of the at least one DL subband; and at least one of an ending RB index or an allocation bandwidth of the additional GB.

Clause 17: The method of Clause 16, wherein the signaling further indicates an offset value indicating a start time when the signaling becomes effective.

Clause 18: The method of Clause 16, wherein the signaling further indicates a symbol and slot configuration pattern, comprising: a first indication of a set of slots during which the signaling is effective; and a second indication of a set of symbols in each slot of the set of slots during which the signaling is effective.

Clause 19: The method of Clause 18, wherein the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

Clause 20: The method of Clause 11, wherein the signaling further indicates: a starting RB index of a first edge GB, wherein the starting RB includes a first edge frequency of a component carrier (CC) including the at least one DL subband and the at least one UL subband; at least one of an ending RB index or a bandwidth of the first edge GB; a starting RB index of a second edge GB having a frequency higher than the frequency of the at least one DL subband and the frequency of the at least one UL subband; and at least one of an ending RB index or a bandwidth of the second edge GB, wherein the ending RB or the bandwidth of the second edge GB includes a second edge frequency of the CC.

Clause 21: The method of any one of Clauses 1-20, wherein the signaling indicates: a starting RB index of a GB having a frequency between the frequency location of the at least one DL subband and the frequency location of the at least one UL subband; at least one of an ending RB index or an allocation bandwidth of the GB; and a starting RB index and at least one of an ending RB index or an allocation bandwidth of the GB of the at least one or more DL subbands or the at least one UL subband.

Clause 22: The method of Clause 21, wherein the signaling further indicates an offset value indicating a start time when the signaling becomes effective.

Clause 23: The method of Clause 21, wherein the signaling further indicates a symbol and slot configuration pattern, comprising: a first indication of a set of slots during which the signaling is effective; and a second indication of a set of symbols in each slot of the set of slots during which the signaling is effective.

Clause 24: The method of Clause 23, wherein the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

Clause 25: The method of any one of Clauses 1-24, further comprising: determining, based on a pre-defined rule, not to adapt an active UL BWP or an active DL BWP in response to the signaling.

Clause 26: The method of any one of Clauses 1-25, further comprising: adapting at least one of an active UL bandwidth part or an active DL bandwidth part in response to the signaling.

Clause 27: The method of any one of Clauses 1-26, further comprising: receiving a BWP switching signal, wherein performing the SBFD communications comprises waiting until receiving the BWP switching signal before performing the SBFD communications, in one or more symbols or slots, based on the signaling.

Clause 28: The method of any one of Clauses 1-27, wherein: the signaling indicates a BWP switch to a first BWP; and the frequency location of the at least one uplink subband or the frequency location of the at least one downlink subband are indicated in a BWP configuration for the first BWP.

Clause 29: The method of Clause 28, wherein the first BWP comprises a first UL BWP that indicates the frequency location of the at least one UL subband, and the method further comprises: receiving a configuration of a semi-static UL BWP switching pattern indicating the BWP configuration for the first UL BWP and a BWP configuration for at least one second UL BWP; and switching from the at least one second UL BWP to the first UL BWP in response to the signaling and based on the semi-static UL BWP switching pattern.

Clause 30: The method of any one of Clauses 1-29, wherein the signaling indicates a first DL BWP configuration comprising the at least one DL subband and another DL subband, wherein the at least one DL subband and the other DL subband are in non-contiguous frequency bands.

Clause 31: The method of Clause 30, further comprising: receiving a configuration of a CSI-RS transmitted via a bandwidth of a component carrier (CC) including the at least one DL subband and the at least one UL subband, wherein the CSI-RS has a CSI-RS resource identifier, receiving a command to report channel state information for the at least one DL subband and the other DL subband, associated with the CSI-RS resource identifier, and reporting a CSI metric in a CSI report for the at least one DL subband and the other DL subband based on CSI-RS within the at least one DL subband and the other DL subband that correspond to the CSI-RS, within the CC, associated with the CSI-RS resource identifier

Clause 32: The method of Clause 31, further comprising: measuring CSI-RS associated with the CSI-RS resource identifier within the at least one DL subband and the other DL subband, wherein the CSI metric is calculated based on the CSI-RS associated with the CSI-RS resource identifier within the at least one DL subband and the other DL subband and not based on CSI-RS associated with the CSI-RS resource identifier outside of the at least one DL subband and the other DL subband.

Clause 33: The method of Clause 32, wherein the UE determines the CSI-RS to measure based on the first DL BWP configuration.

Clause 34: The method of any one of Clauses 1-33, wherein the signaling indicates the frequency locations of the at least one DL subband and another DL subband, wherein the at least one DL subband and the other DL subband are in non-contiguous frequency bands.

Clause 35: The method of Clause 34, further comprising: receiving a DL BWP configuration including a configuration of a CSI-RS, wherein frequency locations of the DL BWP include the frequency locations of the at least one DL subband and the other DL subband, wherein the CSI-RS has a CSI-RS resource identifier, receiving a command to report channel state information associated with the CSI-RS resource identifier, and reporting a CSI metric in a CSI report for the at least one DL subband and the other DL subband based on CSI-RS within the at least one DL subband and the other DL subband that correspond to the CSI-RS associated with the CSI-RS resource identifier

Clause 36: The method of Clause 35, further comprising: measuring CSI-RS associated with the CSI-RS resource identifier within the at least one DL subband and the other DL subband, wherein the CSI metric is calculated based on the CSI-RS associated with the CSI-RS resource identifier within the at least one DL subband and the other DL subband and not based on CSI-RS associated with the CSI-RS resource identifier outside of the at least one DL subband and the other DL subband.

Clause 37: The method of any one of Clauses 1-36, further comprising: receiving a configuration of an UL BWP including a configuration of a SRS to be transmitted by the UE via a bandwidth of the UL BWP, wherein frequency locations of the UL BWP include the frequency locations of the at least one DL subband, receiving a command to transmit SRS, and transmitting SRS in the at least one UL subband based on the configuration of the UL BWP while not transmitting SRS on frequency locations of the BWP that are not included in the UL subband

Clause 38: A method for wireless communications by a network entity, comprising: transmitting signaling indicating at least one of time or frequency locations of at least one UL subband and at least one DL subband for SBFD communications; and performing SBFD communications, in one or more symbols or slots, based on the signaling.

Clause 39: The method of Clause 38, wherein the signaling comprises at least one of a MAC-CE or a DCI.

Clause 40: The method of any one of Clauses 38 and 39, wherein the signaling indicates: a starting RB index for each DL subband of the at least one DL subband; at least one of an ending RB index or an allocation bandwidth for each DL subband of the at least one DL subband; a starting RB index for each UL subband of the at least one UL subband; and at least one of an ending RB index or an allocation bandwidth for each UL subband of the at least one UL subband.

Clause 41: The method of Clause 40, wherein the signaling further indicates an offset value indicating a start time when the signaling becomes effective.

Clause 42: The method of Clause 40, wherein the signaling further indicates a symbol and slot configuration pattern, comprising: a first indication of a set of slots during which the signaling is effective; and a second indication of a set of symbols in each slot of the set of slots during which the signaling is effective.

Clause 43: The method of Clause 42, wherein the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

Clause 44: The method of any one of Clauses 38-43, wherein the signaling comprises: one or more indices of RB sets included in each DL subband of the at least one DL subband; and one or more indices of RB sets included in each UL subband of the at least one UL subband.

Clause 45: The method of Clause 44, wherein the signaling further indicates an offset value indicating a start time when the signaling becomes effective.

Clause 46: The method of Clause 44, wherein the signaling further indicates a symbol and slot configuration pattern, comprising: a first indication of a set of slots during which the signaling is effective; and a second indication of a set of symbols in each slot of the set of slots during which the signaling is effective.

Clause 47: The method of Clause 46, wherein the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

Clause 48: The method of any one of Clauses 38-47, wherein the signaling indicates: an explicit subband frequency configuration pattern indicating a relationship of the frequency location of the at least one DL subband to the frequency location of the at least one UL subband; a starting RB index of a GB having a frequency between the frequency location of the at least one DL subband and the frequency location of the at least one UL subband; and at least one of an ending RB index or an allocation bandwidth of the GB.

Clause 49: The method of Clause 48, wherein the signaling further indicates: a frequency location of an additional DL subband of the at least one DL subband, wherein the explicit subband frequency configuration pattern further indicates a relationship of the frequency location of the additional DL subband to the frequency location of the at least one UL subband; a starting RB index of an additional GB having a frequency between the frequency location of the additional DL subband and the frequency location of the at least one UL subband; and at least one of an ending RB index or an allocation bandwidth of the additional GB.

Clause 50: The method of Clause 49, wherein the signaling further indicates an offset value indicating a start time when the configuration becomes effective.

Clause 51: The method of Clause 49, wherein the signaling further indicates a symbol and slot configuration pattern, comprising: a first indication of a set of slots during which the signaling is effective; and a second indication of a set of symbols in each slot of the set of slots during which the signaling is effective.

Clause 52: The method of Clause 51, wherein the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

Clause 53: The method of Clause 48, wherein the signaling further indicates: a frequency location of an additional UL subband of the at least one UL subband, wherein the explicit subband frequency configuration pattern further indicates a relationship of the frequency location of the additional UL subband to the frequency location of the at least one DL subband; a starting RB index of an additional GB having a frequency between the frequency location of the additional UL subband and the frequency location of the at least one DL subband; and at least one of an ending RB index or an allocation bandwidth of the additional GB.

Clause 54: The method of Clause 53, wherein the signaling further indicates an offset value indicating a start time when the signaling becomes effective.

Clause 55: The method of Clause 53, wherein the signaling further indicates a symbol and slot configuration pattern, comprising: a first indication of a set of slots during which the signaling is effective; and a second indication of a set of symbols in each slot of the set of slots during which the signaling is effective.

Clause 56: The method of Clause 55, wherein the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

Clause 57: The method of Clause 48, wherein the signaling further indicates: a starting RB index of a first edge GB, wherein the starting RB includes a first edge frequency of the CC; at least one of an ending RB index or a bandwidth of the first edge GB; a starting RB index of a second edge GB having a frequency higher than the frequency of the at least one DL subband and the frequency of the at least one UL subband; and at least one of an ending RB index or a bandwidth of the second edge GB, wherein the ending RB or the bandwidth of the second edge GB includes a second edge frequency of the CC.

Clause 58: The method of any one of Clauses 38-57, wherein the signaling indicates: a starting RB index of a GB having a frequency between the frequency location of the at least one DL subband and the frequency location of the at least one UL subband; at least one of an ending RB index or an allocation bandwidth of the GB; and a direction of the at least one DL subband or the at least one UL subband.

Clause 59: The method of Clause 58, wherein the signaling further indicates an offset value indicating a start time when the signaling becomes effective.

Clause 60: The method of Clause 58, wherein the signaling further indicates a symbol and slot configuration pattern, comprising: a first indication of a set of slots during which the signaling is effective; and a second indication of a set of symbols in each slot of the set of slots during which the signaling is effective.

Clause 61: The method of Clause 60, wherein the signaling further indicates frequency locations of a plurality of UL subbands or frequency locations of a plurality of DL subbands, and the symbol and slot configuration pattern further comprises: a third indication of a first subset of slots in the set of slots when a first UL subband in the plurality of UL subbands and a first DL subband in the plurality of DL subbands is configured; and a fourth indication of a second subset of slots in the set of slots when a second UL subband in the plurality of UL subbands and a second DL subband in the plurality of DL subbands is configured.

Clause 62: The method of any one of Clauses 38-61, further comprising: determining, based on a pre-defined rule, not to adapt an active UL BWP or an active DL BWP in response to the signaling.

Clause 63: The method of any one of Clauses 38-62, further comprising: adapting at least one of an active UL bandwidth part or an active DL bandwidth part in response to the signaling.

Clause 64: The method of any one of Clauses 38-63, further comprising: transmitting a BWP switching signal, wherein performing the SBFD communications comprises waiting until transmitting the BWP switching signal before performing the SBFD communications, in one or more symbols or slots, based on the signaling.

Clause 65: The method of any one of Clauses 38-64, wherein: the signaling indicates a BWP switch to a first BWP; and the frequency location of the at least one uplink subband or the frequency location of the at least one downlink subband are indicated in a BWP configuration for the first BWP.

Clause 66: The method of Clause 65, wherein the first BWP comprises a first UL BWP that indicates the frequency location of the at least one UL subband, and the method further comprises: transmitting a configuration of a semi-static UL BWP switching pattern indicating the BWP configuration for the first UL BWP and a BWP configuration for at least one second UL BWP, wherein the signaling indicates a switch based on the semi-static UL BWP switching pattern.

Clause 67: The method of any one of Clauses 38-66, wherein the signaling indicates a first DL BWP configuration comprising the at least one DL subband and another DL subband, wherein the at least one DL subband and the other DL subband are in non-contiguous frequency bands.

Clause 68: The method of Clause 67, further comprising: transmitting a configuration of a CSI-RS transmitted via a bandwidth of the CC, wherein the CSI-RS has a CSI-RS resource identifier, transmitting a command to report channel state information for the at least one DL subband and the other DL subband, associated with the CSI-RS resource identifier, and receiving a CSI metric in a CSI report for the at least one DL subband and the other DL subband based on CSI-RS within the at least one DL subband and the other DL subband that correspond to the CSI-RS within the CC associated with the CSI-RS resource identifier

Clause 69: The method of Clause 68, wherein the CSI metric is calculated based on the CSI-RS associated with the CSI-RS resource identifier within the at least one DL subband and the other DL subband and not based on CSI-RS associated with the CSI-RS resource identifier outside of the at least one DL subband and the other DL subband.

Clause 70: The method of any one of Clauses 38-69, wherein the signaling indicates the frequency locations of the at least one DL subband and another DL subband, wherein the at least one DL subband and the other DL subband are in non-contiguous frequency bands.

Clause 71: The method of Clause 70, further comprising: transmitting a DL BWP configuration including a configuration of a CSI-RS, wherein frequency locations of the DL BWP includes the frequency locations of the at least one DL subband and the other DL subband, wherein the CSI-RS has a CSI-RS resource identifier, transmitting a command to report channel state information associated with the CSI-RS resource identifier, and receiving a CSI metric in a CSI report for the at least one DL subband and the other DL subband based on CSI-RS within the at least one DL subband and the other DL subband that correspond to the CSI-RS associated with the CSI-RS resource identifier

Clause 72: The method of Clause 71, wherein the CSI metric is calculated based on the CSI-RS associated with the CSI-RS resource identifier within the at least one DL subband and the other DL subband and not based on CSI-RS associated with the CSI-RS resource identifier outside of the at least one DL subband and the other DL subband.

Clause 73: The method of any one of Clauses 38-72, further comprising: transmitting a configuration of an UL BWP including a configuration of a SRS to be transmitted via a bandwidth of the UL BWP, wherein frequency locations of the UL BWP include the frequency locations of the at least one DL subband, transmitting a command to transmit SRS, and receiving SRS in the UL subband based on the configuration of the UL subband configuration while not receiving SRS on frequency locations of the BWP that are not included in the UL subband

Clause 74: An apparatus, comprising: a memory comprising executable instructions; and a processor configured to execute the executable instructions and cause the apparatus to perform a method in accordance with any one of Clauses 1-73.

Clause 75: An apparatus, comprising means for performing a method in accordance with any one of Clauses 1-73.

Clause 76: A non-transitory computer-readable medium comprising executable instructions that, when executed by a processor of an apparatus, cause the apparatus to perform a method in accordance with any one of Clauses 1-73.

Clause 77: A computer program product embodied on a computer-readable storage medium comprising code for performing a method in accordance with any one of Clauses 1-73.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications at a user equipment (UE), comprising:
a processor;
memory coupled with the processor; and
instructions stored in the memory and executable by the processor to cause the UE to:
receive signaling indicating at least one of time or frequency locations of at least one uplink (UL) subband and at least one downlink (DL) subband for subband full duplex (SBFD) communications; and
perform SBFD communications, in one or more symbols or slots, based on the signaling.

2. The apparatus of claim 1, wherein the signaling comprises at least one of a medium access control control element (MAC-CE) or a downlink control information (DCI).

3. The apparatus of claim 1, wherein the signaling indicates:
a starting resource block (RB) index for each DL subband of the at least one DL subband, at least one of an ending RB index or an allocation bandwidth for each DL subband of the at least one DL subband, a starting RB index for each UL subband of the at least one UL subband, and at least one of an ending RB index or an allocation bandwidth for each UL subband of the at least one UL subband; or
a starting resource block (RB) index of a guard band (GB) having a frequency between the frequency location of the at least one DL subband and the frequency location of the at least one UL subband, at least one of an ending RB index or an allocation bandwidth of the GB, and a starting resource block (RB) index and at least one of an ending RB index or an allocation bandwidth of the GB of the at least one or more DL subbands or the at least one UL subband.

4. The apparatus of claim 3, wherein the signaling further indicates at least one of:
an offset value indicating a start time when the signaling becomes effective; or
a symbol and slot configuration pattern, comprising:
a first indication of a set of slots during which the signaling is effective; and
a second indication of a set of symbols in each slot of the set of slots during which the signaling is effective.

5. The apparatus of claim 4, wherein the signaling indicates the symbol and slot configuration pattern and further indicates frequency locations of a plurality of UL subbands or frequency locations of a plurality of DL subbands, and the symbol and slot configuration pattern further comprises:
a third indication of a first subset of slots in the set of slots when a first UL subband in the plurality of UL subbands and a first DL subband in the plurality of DL subbands is configured; and
a fourth indication of a second subset of slots in the set of slots when a second UL subband in the plurality of UL subbands and a second DL subband in the plurality of DL subbands is configured.

6. The apparatus of claim 1, wherein the signaling comprises:
one or more indices of resource block (RB) sets included in each DL subband of the at least one DL subband; and
one or more indices of resource block (RB) sets included in each UL subband of the at least one UL subband.

7. The apparatus of claim 6, wherein the signaling further indicates at least one of:
an offset value indicating a start time when the signaling becomes effective; or
a symbol and slot configuration pattern, comprising:
a first indication of a set of slots during which the signaling is effective; and
a second indication of a set of symbols in each slot of the set of slots during which the signaling is effective.

8. The apparatus of claim 7, wherein the signaling indicates the symbol and slot configuration pattern and further indicates frequency locations of a plurality of UL subbands or frequency locations of a plurality of DL subbands, and the symbol and slot configuration pattern further comprises:
a third indication of a first subset of slots in the set of slots when a first UL subband in the plurality of UL subbands and a first DL subband in the plurality of DL subbands is configured; and
a fourth indication of a second subset of slots in the set of slots when a second UL subband in the plurality of UL subbands and a second DL subband in the plurality of DL subbands is configured.

9. The apparatus of claim 1, wherein the signaling indicates:
an explicit subband frequency configuration pattern indicating a relationship of the frequency location of the at least one DL subband to the frequency location of the at least one UL subband;
a starting resource block (RB) index of a guard band (GB) having a frequency between the frequency location of the at least one DL subband and the frequency location of the at least one UL subband; and
at least one of an ending RB index or an allocation bandwidth of the GB.

10. The apparatus of claim 9, wherein the signaling further indicates:
a frequency location of an additional DL subband of the at least one DL subband, wherein the explicit subband frequency configuration pattern further indicates a relationship of the frequency location of the additional DL subband to the frequency location of the at least one UL subband, a starting resource block (RB) index of an additional GB having a frequency between the frequency location of the additional DL subband and the frequency location of the at least one UL subband, and at least one of an ending RB index or an allocation bandwidth of the additional GB; or
a frequency location of an additional UL subband of the at least one UL subband, wherein the explicit subband frequency configuration pattern further indicates a relationship of the frequency location of the additional UL subband to the frequency location of the at least one DL subband, a starting resource block (RB) index of an additional GB having a frequency between the frequency location of the additional UL subband and the frequency location of the at least one DL subband, and at least one of an ending RB index or an allocation bandwidth of the additional GB.

11. The apparatus of claim 10, wherein the signaling further indicates at least one of:
an offset value indicating a start time when the explicit subband frequency configuration pattern becomes effective; or
a symbol and slot configuration pattern, comprising:
a first indication of a set of slots during which the signaling is effective; and
a second indication of a set of symbols in each slot of the set of slots during which the signaling is effective.

12. The apparatus of claim 11, wherein the signaling indicates the symbol and slot configuration pattern and further indicates frequency locations of a plurality of UL subbands or frequency locations of a plurality of DL subbands, and the symbol and slot configuration pattern further comprises:
a third indication of a first subset of slots in the set of slots when a first UL subband in the plurality of UL subbands and a first DL subband in the plurality of DL subbands is configured; and
a fourth indication of a second subset of slots in the set of slots when a second UL subband in the plurality of UL subbands and a second DL subband in the plurality of DL subbands is configured.

13. The apparatus of claim 9, wherein the signaling further indicates:
a starting resource block (RB) index of a first edge GB, wherein the starting RB includes a first edge frequency of a component carrier (CC) including the at least one DL subband and the at least one UL subband;
at least one of an ending RB index or a bandwidth of the first edge GB;
a starting resource block (RB) index of a second edge GB having a frequency higher than the frequency of the at least one DL subband and the frequency of the at least one UL subband; and
at least one of an ending RB index or a bandwidth of the second edge GB, wherein the ending RB or the bandwidth of the second edge GB includes a second edge frequency of the CC.

14. The apparatus of claim 1, wherein the instructions are executable by the processor to further cause the UE to at least one of:
determine, based on a pre-defined rule, not to adapt an active UL bandwidth part (BWP) or an active DL BWP in response to the signaling;
adapt at least one of an active UL bandwidth part or an active DL bandwidth part in response to the signaling; or
receive a bandwidth part (BWP) switching signal, wherein the instructions being executable by the processor to cause the UE to perform the SBFD communications comprises the instructions being executable by the processor to cause the UE to wait until receiving the BWP switching signal before performing the SBFD communications, in one or more symbols or slots, based on the signaling.

15. The apparatus of claim 1, wherein:
the signaling indicates a bandwidth part (BWP) switch to a first BWP; and
the frequency location of the at least one UL subband or the frequency location of the at least one DL subband are indicated in a BWP configuration for the first BWP.

16. The apparatus of claim 15, wherein the first BWP comprises a first UL BWP that indicates the frequency location of the at least one UL subband, and wherein the instructions are executable by the processor to further cause the UE to:
receive a configuration of a semi-static UL BWP switching pattern indicating the BWP configuration for the first UL BWP and a BWP configuration for at least one second UL BWP; and
switch from the at least one second UL BWP to the first UL BWP in response to the signaling and based on the semi-static UL BWP switching pattern.

17. The apparatus of claim 1, wherein the signaling indicates a first DL bandwidth part (BWP) configuration comprising the at least one DL subband and another DL subband, wherein the at least one DL subband and the other DL subband are in non-contiguous frequency bands.

18. The apparatus of claim 17, wherein the instructions are executable by the processor to further cause the UE to:
receive a configuration of a channel state information reference signal (CSI-RS) transmitted via a bandwidth of a component carrier (CC) including the at least one DL subband and the at least one UL subband, wherein the CSI-RS has a CSI-RS resource identifier;
receive a command to report channel state information for the at least one DL subband and the other DL subband, associated with the CSI-RS resource identifier; and
report a CSI metric in a CSI report for the at least one DL subband and the other DL subband based on CSI-RS within the at least one DL subband and the other DL subband that correspond to the CSI-RS, within the CC, associated with the CSI-RS resource identifier.

19. The apparatus of claim 18, wherein the instructions are executable by the processor to further cause the UE to:
measure CSI-RS associated with the CSI-RS resource identifier within the at least one DL subband and the other DL subband, wherein the CSI metric is calculated based on the CSI-RS associated with the CSI-RS resource identifier within the at least one DL subband and the other DL subband and not based on CSI-RS associated with the CSI-RS resource identifier outside of the at least one DL subband and the other DL subband.

20. The apparatus of claim 19, wherein the instructions are executable by the processor to cause the UE to determine the CSI-RS to measure based on the first DL BWP configuration.

21. The apparatus of claim 1, wherein the signaling indicates the frequency locations of the at least one DL subband and another DL subband, wherein the at least one DL subband and the other DL subband are in non-contiguous frequency bands.

22. The apparatus of claim 21, wherein the instructions are executable by the processor to further cause the UE to:
receive a DL bandwidth part (BWP) configuration including a configuration of a channel state information reference signal (CSI-RS), wherein frequency locations of the DL BWP include the frequency locations of the at least one DL subband and the other DL subband, wherein the CSI-RS has a CSI-RS resource identifier;
receive a command to report channel state information associated with the CSI-RS resource identifier; and
report a CSI metric in a CSI report for the at least one DL subband and the other DL subband based on CSI-RS within the at least one DL subband and the other DL subband that correspond to the CSI-RS associated with the CSI-RS resource identifier.

23. The apparatus of claim 22, wherein the instructions are executable by the processor to further cause the UE to:
measure CSI-RS associated with the CSI-RS resource identifier within the at least one DL subband and the other DL subband, wherein the CSI metric is calculated based on the CSI-RS associated with the CSI-RS resource identifier within the at least one DL subband and the other DL subband and not based on CSI-RS associated with the CSI-RS resource identifier outside of the at least one DL subband and the other DL subband.

24. The apparatus of claim 1, wherein the instructions are executable by the processor to further cause the UE to:
receive a configuration of an UL bandwidth part (BWP) including a configuration of a sounding reference signal (SRS) to be transmitted by the UE via a bandwidth of the UL BWP, wherein frequency locations of the UL BWP include the frequency locations of the at least one DL subband;
receive a command to transmit SRS; and
transmit SRS in the at least one UL subband based on the configuration of the UL BWP while not transmitting SRS on frequency locations of the BWP that are not included in the UL subband.

25. An apparatus for wireless communications at a network entity, comprising:
a processor;
memory coupled with the processor; and
instructions stored in the memory and executable by the processor to cause the network entity to:
transmit signaling indicating at least one of time or frequency locations of at least one uplink (UL) subband and at least one downlink (DL) subband for subband full duplex (SBFD) communications; and
perform SBFD communications, in one or more symbols or slots, based on the signaling.

26. The apparatus of claim 25, wherein the signaling comprises at least one of a medium access control control element (MAC-CE) or a downlink control information (DCI).

27. The apparatus of claim 25, wherein the signaling indicates:
a starting resource block (RB) index for each DL subband of the at least one DL subband, at least one of an ending RB index or an allocation bandwidth for each DL subband of the at least one DL subband, a starting RB index for each UL subband of the at least one UL subband, and at least one of an ending RB index or an allocation bandwidth for each UL subband of the at least one UL subband; or
a starting resource block (RB) index of a guard band (GB) having a frequency between the frequency location of the at least one DL subband and the frequency location of the at least one UL subband, at least one of an ending RB index or an allocation bandwidth of the GB, and a direction of the at least one DL subband or the at least one UL subband.

28. The apparatus of claim 27, wherein the signaling further indicates an offset value indicating a start time when the signaling becomes effective.

29. A method for wireless communications by a user equipment (UE), comprising:
receiving signaling indicating at least one of time or frequency locations of at least one uplink (UL) subband and at least one downlink (DL) subband for subband full duplex (SBFD) communications; and
performing SBFD communications, in one or more symbols or slots, based on the signaling.

30. A method for wireless communications by a network entity, comprising:
transmitting signaling indicating at least one of time or frequency locations of at least one uplink (UL) subband and at least one downlink (DL) subband for subband full duplex (SBFD) communications; and
performing SBFD communications, in one or more symbols or slots, based on the signaling.
